(19) United States
(12) Patent Application Publication
(10) Pub. No.: US 2021/0071781 A1
(43) Pub. Date: Mar. 11, 2021

(54) AUTOMATED PIPELINE CONSTRUCTION APPARATUS, SYSTEM AND METHOD

(71) Applicant: JRAMCO INC., Calgary (CA)

(72) Inventors: Jerome RAMSAY, Calgary (CA); Keith MICKEY, Calgary (CA); Jim ORCHERTON, Calgary (CA); Robert STEWART, Calgary (CA)

(21) Appl. No.: 17/012,992

(22) Filed: Sep. 4, 2020

(30) Foreign Application Priority Data
Sep. 6, 2019 (CA) 3054504

(51) Int. Cl. F16L 1/024; E02F 5/10; F16L 1/06; F16L 1/036; F16L 1/10

(52) U.S. Cl. CPC F16L 1/0243; E02F 5/10; F16L 1/10; F16L 1/036; F16L 1/065

(57) ABSTRACT

An automated pipeline-construction system and method for constructing a pipeline and laying constructed pipeline in various terrain conditions. The system has one or more pipeline-racking vehicles arranged in series for storing a plurality of pipeline joints, and a self-propelled pipeline-construction vehicle behind the pipeline-racking vehicles for receiving pipeline joints one-by-one therefrom and automatically coupling each received pipeline joint to the constructed pipeline through a pipeline construction and deployment process. A computing structure controls the pipeline-racking vehicles and pipeline-construction vehicle to align them at least laterally and to synchronously move forward for deploying the constructed pipeline. Each of the one or more pipeline-racking vehicles and the pipeline-construction vehicle may comprise a moving structure, and the computing structure may control the moving structures thereof for leveling the one or more pipeline-racking vehicles and the pipeline-construction vehicle.

### CROSS-REFERENCE TO RELATED APPLICATIONS

This application claims the benefit of Canadian Patent Application Serial No. 3,054,504, filed Sep. 6, 2019, the content of which is incorporated herein by reference in its entirety.

### FIELD OF THE DISCLOSURE

The present disclosure relates generally to automated pipeline-construction apparatus, system and method, and in particular to an automated apparatus, system and method for laying pipes in various terrain conditions.

### BACKGROUND

Pipelines are an important part of the oil and gas industry necessary for long-distance transportation of oil and gas such as crude oil and/or natural gas from a source site to a target site. Herein, the source site may be an oil/gas production site, an oil/gas transportation hub, and/or the like, and the target site may be an oil/gas transportation hub, a refinery facility, a shipping terminal, and/or the like.

The general process of pipeline construction is known. Generally, a pipeline is built by sequentially interconnecting a plurality of pipes and laying the interconnected pipes on the ground or burying at a depth of about 3′ to about 6′ (i.e., about 3 feet to about 6 feet, or about 0.9 meters (m) to about 1.8 m). As the pipes are usually made of steel and have a large diameter such as between about 4″ to about 48″ (i.e., about 4 inches to about 48 inches, or about 10.2 centimeters (cm) to about 122 cm), a large number of heavy equipment, supplies, and workers are usually required in pipeline construction. Moreover, pipeline construction usually requires wide right-of-ways to be built during the process. Although a portion of the right-of-way may be reclaimed after the completion of the pipeline-construction process for reducing the environmental impact, the building of wide right-of-ways still increases the pipeline-construction cost and unavoidably affects the environment surrounding the construction site.

US Patent Application Publication No. 2003/0039509 by McIvor teaches an apparatus for producing a pipeline including a plurality of vehicles for straddling a ditch. All of the vehicles are transported on wide, relatively soft tires for minimizing damage to the soil surface. A first vehicle receives, aligns and maintains sections of pipe in position over a trench while effecting a first weld. Additional welding of the joints between pipe sections is affected in successive vehicles, and the weld joint is inspected and then coated with plastic. Finally, the pipeline is deposited in the trench, and the trench is then backfilled by the last vehicle in the train of vehicles.

U.S. Pat. No. 7,726,909 issued to Miller et al. teaches an apparatus, system, and method for concurrently forming a plurality of pipelines. The apparatus includes a support chassis coupled to at least one transportation facilitation member. The transportation facilitation member facilities the movement of the support chassis along a surface. A first pipe fuser is disposed on the support chassis and is configured to fuse a first section of pipe to a first pipeline. A second pipe fuser may also be disposed on the support chassis. The second pipe fuser may be configured to independently fuse a second section of pipe to a second pipeline. The first pipe fuser fuses the first section of pipe to the first pipeline with the support chassis in a stationary position. The second pipe fuser fuses the second section of pipe to the second pipeline with the support chassis in the same stationary position.

U.S. Pat. No. 7,161,115 issued to Stecher et al. teaches a method and a vehicle-mounted apparatus for laying pipelines in which adjacent pipe are joined by the technique of magnetically impelled arc butt welding (MIAB). A MIAB welding head having a welding axis is mounted on a transportable platform. A pipe guide capable of engaging a welded pipe string is located rearwardly of the welding head. The pipe guide maintains alignment of the string with the welding axis. The apparatus includes pipe feed means maintaining alignment of a next pipe to be laid with the welding axis and the pipe string. The platform is rotatably mounted on the vehicle and tilts around a horizontal axis. The vehicle is provided with pivoting steerable tracks.

U.S. Pat. No. 6,969,215 issued to Duncan teaches a method of constructing a pipeline in steep terrain by digging a ditch on an incline, assembling pipeline joints together adjacent a top of the incline and then lowering the assembled pipeline joints into the ditch along the incline. A wheeled assembly at the lower end of the pipeline carries much of the load and rolls down the ditch as allowed by winch equipment at the top of the incline. Bearing supports are installed periodically in the ditch to support the pipeline, the supports being of a softer material than coatings on the pipe.

U.S. Pat. No. 7,607,863 issued to Paull discloses a trench box including a pair of oppositely disposed parallel elongated sidewalls defining a work volume, distal and proximal support members extending between the sidewalls, and a track positioned between the sidewalls. Track-adjusting members extend between the track and the support members, and a movable tram-connecting plate is connected to the track. An actuator is coupled to the track and is energizable to move the tram connecting plate and a tool module is operationally connectable to the tram-connecting plate. A pipe-dispensing assembly and a gravel hopper assembly are positionable within the working volume.

US Pat. Appl. Pub. No. 2005/0117973 by Nelson teaches a system and a method for laying a pipe in a trench. Grading is done on pipe bed material in a trench by a remotely controlled earthmover included in a first subsystem. Pipe sections are joined to a pipe by remote control by an operator or operators outside of the trench using a second subsystem. A pipe section is lifted by a first gripper on a transport assembly and lowered into the trench in alignment with the pipe. A second gripper on the transport assembly grasps an end of the pipe, and the first gripper moves axially to insert the pipe section into the pipe. The earthmover has a material-pushing blade mounted to the pivot arms in a manner to enable a single hydraulic actuator for each pivot arm to determine height and tilt of the blade.

US Pat. Appl. Pub. No. 2013/0121769 by Gately teaches an automated device having a retractable side boom and an associated retractable descendent/downwardly extending boom. The device may further comprise a gripping assembly which is capable of setting a pipe gripped therein to a specific slope or gradient, thus allowing for maximum precision in for example a pipe laying process. The side and descendent booms are operable to deliver a pipe such as a pipe section into a trench.

U.S. Pat. No. 8,764,344 issued to Simoncelli et al. teaches a method for laying a pipe including predisposing first and second releasable gripping devices for firmly gripping or releasing the pipe. The gripping devices are located along the longitudinal direction of the pipe. The gripping devices when activated grip and move the pipe so that only a predetermined longitudinal pipe section is received in the laying site. The gripping devices are rearranged and activated, instant by instant, so that the pipe is at all times solidly gripped by at least one gripping device. The above step is repeated until multiple longitudinal sections are housed in the laying site. A machine for laying pipe has gripping devices independently activatable for firmly gripping or releasing the pipe and also for moving the first and/or second gripping devices a predetermined number of times while gripping the pipe, for moving multiple longitudinal pipe sections into the laying site.

U.S. Pat. No. 9,109,343 issued to Baldinger et al. teaches a method and a device for producing a pipe bed or a pipe bed profiling. The method includes: digging a trench, producing a trench floor, producing the pipe bed or pipe bed profiling by a pipe-bed finisher adapted in at least one sub-region of its outer contours to the outer contours of the pipe to be laid, and on its longitudinal sides, at least one guide or side element projects laterally on each of its two sides. The device has a pipe-bed finisher, shape-adapted in at least one sub-region of its outer contours to an outer contour of the pipe to be laid. The pipe-bed finisher is constructed either as a pipe profiling arbor that has at least on one front end, a finished guide tip or as a pipe profiling sleeve that has a punch-like, open or closed, concave or convex sleeve end region in the advancing direction.

U.S. Pat. No. 8,166,201 issued to Gomes teaches a system and a method for installation of duct lines and/or pipelines comprising a pipe shop, supporting, rolling and guiding elements previously provided along a path of duct line/pipeline designed to be formed, the quantity of elements varying according to the length and the characteristics of the path, the said pipe shop comprising within the same a facility for welding, inspection and finishing of the pipes for forming the duct line/pipeline, the elements comprising a supporting base and a roller.

U.S. Pat. No. 9,057,458 issued to Rettkowski teaches a single-operator extruder main body dispensing aggregate, pipe and geotextile during a trenching operation. Lifting elements allows the main body to be manipulated by a single operator.

U.S. Pat. No. 8,152,412 to Davis teaches a pipe-layer having an undercarriage with at least two tracks and a main assembly. Each track has a track frame coupled to the undercarriage and a track shoe supported by and movable around the track frame. The main assembly is supported by and rotatable relative to the undercarriage, and has a main frame, a boom pivotally mounted to the main frame, an operator cab, and a cab riser connecting the operator cab to the main frame. The cab riser is operable to selectively raise and lower the operator cab relative to the main frame. Also provided is a movable cab assembly having an operator cab, an adjustment mechanism to connect the cab to a vehicle frame and move to change the operator's view, and a guide to align the cab. A method for laying pipe using a pipelayer having a movable cab is also disclosed.

US Pat. Appl. Pub. No. 2006/0171782 by Neiwert teaches a system for preparing earthen beds for installation of pipe thereon comprising a trench support frame, disposable at least partially within an earthen trench in which pipe is to be installed. A grading assembly is coupled to and movable within the trench support frame. A bedding material supply system is integrated with the trench support frame, the bedding material supply system being configured to provide bedding material to be graded by the grading assembly to prepare a floor of the earthen trench for installation of the pipe within the trench.

While efforts have been made in prior art for automating and simplifying the pipeline-construction processes, there is always a desire for a pipeline-construction apparatus, system and method with reduced cost and alleviated environmental impact.

### SUMMARY

According to one aspect of this disclosure, there is disclosed a self-propelled semi-automated remote-controllable apparatus for sealably engaging sections of fluid transmission pipeline joints end-to-end thereby producing a continuous long-distance fluid transmission pipeline for installation between a first location for receiving therefrom a supply of a fluid and a second location for delivery thereto of the fluid. Said apparatus comprises: a source of motive power; a rolling chassis in communication with the source of motive power, said rolling chassis having a perimeter encircling a front section, a mid section, and a rear section, wherein: the front section is provided with a first conveyance mount provided with equipment for (i) receiving, engaging thereon, and conveying therealong to the mid section, an end of a fluid transmission pipeline joint; the mid section is provided with remote-controlled equipment for (ii) receiving the end of the fluid transmission pipeline joint from the front section and aligning the end of the pipeline joint with a forward-facing end of a continuous fluid transmission pipeline engaged thereonto a second conveyance mount provided therefor in the mid section, (iii) sealably engaging the end of the fluid transmission pipeline joint with the forward-facing end of the continuous fluid transmission pipeline thereby producing an engaged joint, (iv) inspection of the engaged joint to assess if or if not the engaged joint has been sealably engaged, and (v) repairing the engaged joint if the engaged joint has not been sealably engaged; and the rear section is provided with a third conveyance mount for receiving thereonto and conveying therealong, a rearward-facing end of the continuous fluid transmission pipeline, and with equipment for (vi) sealable installation of a covering thereonto the engaged joint, (vii) deploying one or more cables adjacent to the continuous fluid transmission pipeline and securing the one or more deployed cables to the continuous fluid transmission pipeline, said one or more cables comprising therealong sensors for detection of volatile and/or liquid fluid components and cathodic protection components; and the apparatus also comprises a framework having bottom elements engaged with and extending upward from the perimeter of the rolling chassis, and top elements engaged with and supporting a (viii) superstructure mounted thereon, said superstructure separated into at least (ix) a first section and (x) a second section wherein the first section houses therein the source of motive power, and the second section houses therein (xi) hardware, software, and instrumentation and/or cathodic protection components for remotely operating, controlling, and monitoring the apparatus, and (xii) one or more operator control stations.

In some embodiments, the rolling chassis comprises a first rolling chassis demountably engageable with a second rolling chassis, wherein: the first rolling chassis comprises the front section of the chassis, and has a first framework having bottom elements engaged with and extending upward from a perimeter of the first rolling chassis, and top elements engaged with and supporting a first superstructure mounted thereon, said first superstructure configured for housing therein hardware, software, and instrumentation and/or cathodic protection components for remotely operating, controlling, and monitoring the apparatus, and one or more operator control stations; and the second rolling chassis comprises the mid section and the rear section of the chassis, and has a second framework having bottom elements engaged with and extending upward from a perimeter of the second rolling chassis, and top elements engaged with and supporting a second superstructure mounted thereon, said second superstructure configured for housing therein the source of motive power.

In some embodiments, the rolling chassis comprises at least two or more pairs of high-flotation weight-dispersing tires or tracks therealong, said two or more pairs of high-flotation weight-dispersing tires or tracks in communication with the source of motive power.

In some embodiments, the source of motive power is in communication with one or more internal-combustion engines.

In some embodiments, the one or more internal-combustion engines are in motive communication with the rolling chassis.

In some embodiments, the one or more internal-combustion engines are in communication with one or more electrical-power generators, said electrical-power generators in motive communication with the rolling chassis.

In some embodiments, said electrical-power generators are in communication with a plurality of electrical-power storage batteries housed in one or more of the rolling chassis and the first and/or the second superstructure.

In some embodiments, said plurality of electrical-power storage batteries is in motive communication with the rolling chassis.

In some embodiments, the self-propelled semi-automated remote-controllable apparatus additionally comprises an apparatus in communication with the one or more internal-combustion engines to capture excess heat generated therefrom and to generate electrical power from said excess heat whereby the electrical power is transmissible as motive power to the rolling chassis and/or is in communication with the plurality of electrical-power storage batteries.

In some embodiments, the mid section of the rolling chassis is provided with a robotic, remote-controllable apparatus for sealably engaging the end of a metal fluid-transmission pipeline joint with the forward-facing end of a metal continuous fluid transmission pipeline.

In some embodiments, the mid section of the rolling chassis is provided with a robotic, remote-controllable apparatus for sealably engaging the end of a plastic fluid-transmission pipeline joint with the forward-facing end of a plastic continuous fluid transmission pipeline.

In some embodiments, the mid section of the rolling chassis is provided with a robotic, remote-controllable apparatus for sealably engaging the end of a composite fluid transmission composite pipeline joint with the forward-facing end of a composite continuous fluid transmission pipeline.

According to one aspect of this disclosure, there is provided a system for sealably engaging sections of fluid transmission pipes end-to-end thereby producing a continuous fluid transmission pipeline and for installation of the continuous fluid transmission pipeline between a first location for receiving therefrom a supply of a fluid and a second location for delivery thereto of the fluid. Said system comprises: an above-described self-propelled semi-automated remote-controllable apparatus; a supply of fluid transmission pipeline joints deliverable to the front section of the self-propelled semi-automated remote-controllable apparatus; and a computer-implemented method for operation of the self-propelled semi-automated remote-controllable apparatus.

In some embodiments, the supply of fluid-transmission pipeline joints comprises metal pipeline joints.

In some embodiments, the supply of fluid-transmission pipeline joints comprises plastic pipeline joints.

In some embodiments, the supply of fluid-transmission pipeline joints comprises composite pipeline joints.

In some embodiments, the supply of supply of a fluid is comprises hydrocarbons.

In some embodiments, the hydrocarbons are in the form of a liquid.

In some embodiments, the hydrocarbons are in the form of a gas.

In some embodiments, the supply of supply of a fluid is in a form of liquid water.

In some embodiments, the supply of supply of a fluid is in a form of gaseous water.

In some embodiments, the system additionally comprises equipment for controllable installation of the continuous fluid transmission pipeline along a ground surface from the first location to the second location.

In some embodiments, the system additionally comprises equipment for controllable installation of the continuous fluid transmission pipeline onto a series of aboveground support structures provided therefor from the first location to the second location.

In some embodiments, the system additionally comprises additionally configured with equipment for erection of said series of aboveground support structures and installation of the continuous fluid-transmission pipeline thereonto.

In some embodiments, the system additionally comprises additionally comprising equipment for subterranean installation of the continuous fluid transmission pipeline.

In some embodiments, the equipment for subterranean installation of the continuous fluid transmission pipeline comprises: rolling equipment attached or detached to the self-propelled semi-automated remote-controllable apparatus for digging a trench in front thereof; and rolling equipment for filling in the trench behind the self-propelled semi-automated remote-controllable apparatus.

According to one aspect of this disclosure, there is provided a use of the system described above, for producing a continuous fluid transmission pipeline for installation of the continuous fluid transmission pipeline along a ground surface from a first location to a second location.

According to one aspect of this disclosure, there is provided a use for producing a continuous fluid transmission pipeline for aboveground installation of the continuous fluid transmission pipeline from a first location to a second location.

According to one aspect of this disclosure, there is provided a use for producing a continuous fluid transmission pipeline for subterranean installation of the continuous fluid transmission pipeline from a first location to a second location.

According to one aspect of this disclosure, there is provided a method for producing a continuous fluid transmission pipeline and for installation of the continuous fluid transmission pipeline along a ground surface from a first location to a second location. The method comprises: operating the rolling chassis of the above-described self-propelled semi-automated remote-controllable apparatus, along a designated path from the first location to the second location; delivering a plurality of fluid transmission pipeline joints to the front section of the apparatus; operating the remote-controlled equipment for receiving a front end of the fluid transmission pipeline joint from the front section of the apparatus, and aligning the end of the pipeline joint with a forward-facing end of a continuous fluid transmission pipeline engaged thereonto a second conveyance mount provided therefor in the mid section, sealably engaging the front end of the fluid transmission pipeline joint with the forward-facing end of the continuous fluid transmission pipeline thereby producing an engaged joint, inspection of the engaged joint to assess if or if not the engaged joint has been sealably engaged, repairing the engaged joint if the engaged joint has not been sealably engaged, sealable installation of a covering thereonto the sealably engaged joint, deploying one or more cables adjacent to the continuous fluid transmission pipeline and securing the one or more deployed cables to the continuous fluid transmission pipeline, said one or more cables comprising sensors therealong for detection of volatile and/or liquid fluid components; the method also comprises: delivering the continuous fluid transmission pipeline from the rear section of the apparatus onto a ground surface along the designated path.

In some embodiments, the method further comprises securing the delivered continuous fluid transmission pipeline onto the ground surface.

According to one aspect of this disclosure, there is provided a method for producing a continuous fluid transmission pipeline and for installation of the continuous fluid transmission pipeline onto a series of above-ground supports from a first location to a second location, the method comprises: operating the rolling chassis of the above-described self-propelled semi-automated remote-controllable apparatus, along a designated from the first location to the second location; delivering a plurality of fluid transmission pipeline joints to the front section of the apparatus; operating the remote-controlled equipment for receiving a front end of the fluid transmission pipeline joint from the front section of the apparatus, and aligning the end of the pipeline joint with a forward-facing end of a continuous fluid transmission pipeline engaged thereonto a second conveyance mount provided therefor in the mid section, sealably engaging the front end of the fluid transmission pipeline joint with the forward-facing end of the continuous fluid transmission pipeline thereby producing an engaged joint, inspection of the engaged joint to assess if or if not the engaged joint has been sealably engaged, repairing the engaged joint if the engaged joint has not been sealably engaged, sealable installation of a covering thereonto the sealably engaged joint, deploying one or more cables adjacent to the continuous fluid transmission pipeline and securing the one or more deployed cables to the continuous fluid transmission pipeline, said one or more cables comprising sensors therealong for detection of volatile and/or liquid fluid components; the method also comprises: delivering the continuous fluid transmission pipeline from the rear section of the apparatus onto the series of above-ground support structures; and securing the continuous fluid transmission pipeline to the series of above-ground support structures.

According to one aspect of this disclosure, there is provided a method for producing a continuous fluid transmission pipeline and for subterranean installation of the continuous fluid transmission pipeline from a first location to a second location. The method comprises: providing a trench along a designated path from the first location to the second location; operating the rolling chassis of the above-described self-propelled semi-automated remote-controllable apparatus, along the designated path whereby the apparatus straddles the trench; delivering a plurality of fluid transmission pipeline joints to the front section of the apparatus; operating the remote-controlled equipment for receiving a front end of the fluid transmission pipeline joint from the front section of the apparatus, and aligning the end of the pipeline joint with a forward-facing end of a continuous fluid transmission pipeline engaged thereonto a second conveyance mount provided therefor in the mid section, sealably engaging the front end of the fluid transmission pipeline joint with the forward-facing end of the continuous fluid transmission pipeline thereby producing an engaged joint, inspection of the engaged joint to assess if or if not the engaged joint has been sealably engaged, repairing the engaged joint if the engaged joint has not been sealably engaged, sealable installation of a covering thereonto the sealably engaged joint, deploying one or more cables adjacent to the continuous fluid transmission pipeline and securing the one or more deployed cables to the continuous fluid transmission pipeline, said one or more cables comprising sensors therealong for detection of volatile and/or liquid fluid components; the method also comprises: delivering the continuous fluid transmission pipeline from the rear section of the apparatus into the trench or laying the continuous fluid transmission pipeline on skids; and filling in the trench.

In some embodiments, each skid has a size of about 4″×about 6″×about 4′ (i.e., about 4 inches by about 6 inches by about 4 feet, or about 10.2 centimeters (cm) by about 15.2 cm by about 1.2 meters (m)).

In some embodiments, the continuous fluid transmission pipeline is a metal continuous fluid transmission pipeline.

In some embodiments, the continuous fluid transmission pipeline is a plastic continuous fluid transmission pipeline.

In some embodiments, the continuous fluid transmission pipeline is a composite continuous fluid transmission pipeline.

According to one aspect of this disclosure, there is provided one or more non-transitory computer-readable storage devices comprising computer-executable instructions for producing a continuous fluid transmission pipeline and for installation of the continuous fluid transmission pipeline along a ground surface from a first location to a second location, wherein the instructions, when executed, cause a processing structure to perform actions comprising: operating a rolling chassis of a self-propelled semi-automated remote-controllable apparatus, along a designated path from the first location to the second location; delivering a plurality of fluid transmission pipeline joints to a front section of the apparatus; operating a remote-controlled equipment for receiving a front end of one of the fluid transmission pipeline joints from the front section of the apparatus, and aligning the pipeline joint with a forward-facing end of a continuous fluid transmission pipeline engaged thereonto a second conveyance mount provided therefor in a mid section, sealably engaging a front end of the fluid transmission pipeline joint with the forward-facing end of the continuous fluid transmission pipeline thereby producing an engaged joint, inspection of the engaged joint to assess if or if not the engaged joint has been sealably engaged, repairing the engaged joint if the engaged joint has not been sealably engaged, sealable installation of a covering thereonto the sealably engaged joint, deploying one or more cables adjacent to the continuous fluid transmission pipeline and securing the one or more deployed cables to the continuous fluid transmission pipeline, said one or more cables comprising sensors therealong for detection of volatile and/or liquid fluid components; the instructions, when executed, cause the processing structure to also perform actions comprising: delivering the continuous fluid transmission pipeline from the rear section of the apparatus onto a ground surface along the designated path.

In some embodiments, the instructions, when executed, cause the processing structure to perform further actions comprising: leveling the apparatus such that a longitudinal slope of the apparatus on a longitudinally uneven terrain is within a predefined longitudinal angular range, wherein the longitudinally uneven terrain has a longitudinal length greater than or equal to that of the apparatus and with a grading having a radius of curvature less than or equal to a predefined threshold radius.

In some embodiments, the predefined threshold radius is 100 m.

In some embodiments, the instructions, when executed, cause the processing structure to perform further actions comprising: leveling the apparatus such that a lateral slope of the apparatus is within a predefined lateral angular range.

### BRIEF DESCRIPTION OF THE DRAWINGS

FIGS. 1 and 2 are perspective views of an automated pipeline-construction system, according to some embodiments of this disclosure, the automated pipeline-construction system comprising one or more pipeline-racking vehicles and a pipeline-construction vehicle arranged in series;

FIG. 3 is a perspective view of the pipeline-racking vehicle of the automated pipeline-construction system shown in FIG. 1;

FIG. 4 is a perspective view of the pipeline-racking vehicle shown in FIG. 3 for illustrating a conveying structure thereof;

FIG. 5 is a perspective view of the pipeline-construction vehicle of the automated pipeline-construction system shown in FIG. 1;

FIG. 6 is a side view of the pipeline-construction vehicle shown in FIG. 5;

FIG. 7 is a perspective view of a track assembly of the pipeline-racking vehicle shown in FIG. 3 and/or the pipeline-construction vehicle shown in FIG. 5;

FIG. 8 is a schematic diagram of a control system for adjusting the track assemblies shown in FIG. 7;

FIGS. 9 to 11 are side views of the pipeline-construction vehicle shown in FIG. 5, illustrating the leveling thereof for adapting to uneven terrains;

FIG. 12 is a perspective view of a portion of a lower level of the housing of the pipeline-construction vehicle shown in FIG. 5, illustrating an operation zone thereof for pipeline construction;

FIG. 13 is a schematic side view of the lower level of the housing of the pipeline-construction vehicle shown in FIG. 5, illustrating the pipeline-construction components therein;

FIG. 14 is a perspective view of a roller of a conveying structure of the pipeline-construction vehicle shown in FIG. 5;

FIG. 15 is a cross-sectional view of the roller shown in FIG. 14, the roller receiving thereon a pipeline joint;

FIG. 16 is a perspective view of a tool assembly installed in the lower level of the housing of the pipeline-construction vehicle shown in FIG. 5;

FIGS. 17 and 18 are schematic perspective views of an upper level of the housing of the pipeline-construction vehicle shown in FIG. 5;

FIG. 19 is a perspective view of the pipeline-construction vehicle shown in FIG. 5, illustrating one or more cranes and a plurality of lights thereon;

FIG. 20 is a schematic diagram of a control subsystem of the automated pipeline-construction system shown in FIG. 1, according to some embodiments of this disclosure;

FIG. 21 is a schematic diagram showing a simplified hardware structure of a monitoring computing device of the control subsystem shown in FIG. 20;

FIG. 22 a schematic diagram showing a simplified software architecture of the monitoring computing device of the control subsystem shown in FIG. 20;

FIG. 23 is a block diagram showing a functional structure of the control subsystem shown in FIG. 20;

FIGS. 24 to 26 show an example of one or more alignment sensors of a sensing structure of the control subsystem shown in FIG. 20 for alignment between the pipeline-racking vehicle shown in FIG. 3 and the pipeline-construction vehicle shown in FIG. 5;

FIG. 27 is a cross-sectional view of a conveying structure of the pipeline-construction vehicle shown in FIG. 5, according to some embodiments of this disclosure, wherein the conveying structure comprises a pair of vertically oriented side-rollers;

FIG. 28 shows a portion of the lower level of the pipeline-construction vehicle shown in FIG. 5, illustrating an internal alignment tool for aligning the pipeline joint and the constructed pipeline when the pipeline joint and the constructed pipeline are close to each other;

FIG. 29 is a schematic side view of the internal alignment tool shown in FIG. 28 in a radially retracted configuration;

FIG. 30 is a schematic side view of the internal alignment tool shown in FIG. 28 in a radially extended configuration;

FIGS. 31 to 33 are schematic diagrams showing the determination of the position of the proximal end of the constructed pipeline and the position of the pipeline joint to be coupled to the proximal end of the constructed pipeline, according to some embodiments of this disclosure;

FIGS. 34 to 37 are schematic diagrams showing the pipeline-construction vehicle shown in FIG. 5, according to some embodiments of this disclosure, wherein the pipeline joint and the constructed pipeline are maintained at a fixed location therein, and wherein the pipeline-construction vehicle comprises a plurality of tool assemblies movable along a longitudinal direction for coupling the pipeline joint to the constructed pipeline;

FIGS. 38 to 41 are schematic diagrams showing the pipeline-construction vehicle shown in FIG. 5, according to some embodiments of this disclosure, wherein the pipeline joint and the constructed pipeline are movable therein along the longitudinal direction thereof, and wherein the pipeline-construction vehicle comprises a plurality of tool assemblies at fixed locations for coupling the pipeline joint to the constructed pipeline;

FIGS. 41 to 45 are schematic diagrams showing the pipeline-construction vehicle shown in FIG. 5, according to some embodiments of this disclosure, wherein the pipeline joint and the constructed pipeline are movable therein along the longitudinal direction thereof, and wherein the pipeline-construction vehicle comprises a plurality of tool assemblies each movable within a respective zone for coupling the pipeline joint to the constructed pipeline;

FIG. 46 is a flowchart showing the steps of a pipeline construction and deployment process, according to some embodiments of this disclosure;

FIGS. 47 to 69 show an example of the pipeline construction and deployment process shown in FIG. 46, wherein:

FIG. 47 shows a transportation helicopter transporting a rack having a plurality of pipeline joints to the pipeline-racking vehicle shown in FIG. 3,

FIG. 48 is a perspective view of a self-propelled trenching module arranged on a pipeline-construction trail in front of the pipeline-racking vehicle shown in FIG. 3,

FIG. 49 is a perspective view of the self-propelled trenching module shown in FIG. 48 digging a trench for pipeline deployment,

FIG. 50 is a front view of the pipeline-racking vehicle shown in FIG. 3 and the pipeline-construction vehicle shown in FIG. 5, illustrating selection of a pipeline joint in the pipeline-racking vehicle and delivery of the selected pipeline joint into the pipeline-construction vehicle,

FIG. 51 is a perspective view of a portion of the pipeline-construction vehicle shown in FIG. 5, illustrating the pipeline joint moving on the conveying structure in the pipeline-construction vehicle towards the constructed pipeline,

FIG. 52 is a perspective view of a portion of the pipeline-construction vehicle shown in FIG. 5, illustrating an internal alignment and preheat tool moving into the pipeline joint to locate the front head thereof in the pipeline joint while maintaining the rear end thereof in the constructed pipeline for alignment of the pipeline joint and the constructed pipeline,

FIGS. 53 to 55 are perspective views of a portion of the pipeline-construction vehicle shown in FIG. 5, illustrating a sanding tool sanding the butt joint of the pipeline joint and the constructed pipeline for welding preparation,

FIGS. 56 and 57 are perspective views of a portion of the pipeline-construction vehicle shown in FIG. 5, illustrating a welding tool welding the butt joint,

FIGS. 58 and 59 are perspective views of a portion of the pipeline-construction vehicle shown in FIG. 5, illustrating an inspection tool inspecting the welded butt joint,

FIGS. 60 and 61 are perspective views of a portion of the pipeline-construction vehicle shown in FIG. 5, illustrating a repairing tool repairing a defected butt joint,

FIGS. 62 to 64 are perspective views of a portion of the pipeline-construction vehicle shown in FIG. 5, illustrating a coating tool coating the welded butt joint,

FIGS. 65 and 66 are perspective views of a portion of the pipeline-construction vehicle shown in FIG. 5, illustrating an instrumentation tool installing and securing instrumentation and cathodic protection components to the constructed pipeline,

FIGS. 67 and 68 are perspective views of a portion of the pipeline-construction vehicle shown in FIG. 5, illustrating the constructed pipeline passing through a stress collar for deploying into the trench, and

FIG. 69 is a perspective view of a portion of the pipeline-construction vehicle shown in FIG. 5, illustrating the constructed pipeline is deployed into the trench and a self-propelled trench-filling module filling the pipeline-deployed trench;

FIG. 70 is a schematic side view of a portion of the pipeline-construction vehicle shown in FIG. 5, according to some embodiments of this disclosure, the pipeline-construction vehicle comprising a plurality of wheels;

FIG. 71 is a schematic side view of a portion of the pipeline-construction vehicle shown in FIG. 5, according to some embodiments of this disclosure, the pipeline-construction vehicle comprising a plurality of long tracks;

FIG. 72 is a schematic side view of a pipeline-racking-and-construction vehicle of the automated pipeline-construction system shown in FIG. 1, according to some embodiments of this disclosure, wherein the pipeline-racking-and-construction vehicle is an integration of the pipeline-racking vehicle shown in FIG. 3 and the pipeline-construction vehicle shown in FIG. 5; and

FIG. 73 is a schematic side view of the automated pipeline-construction system shown in FIG. 1, according to some embodiments of this disclosure, wherein the automated pipeline-construction system comprises a plurality of pipeline-construction vehicle each having one or more tool assemblies therein.

### DETAILED DESCRIPTION

Embodiments herein disclose an automated pipeline-construction system and method for constructing a continuous fluid-transmission pipeline and laying the constructed pipeline in various terrain conditions for long-distance transmission of gases or fluids which may be hydrocarbons in a gas phase (e.g., natural gas, gaseous water, and/or the like) or hydrocarbons in a liquid phase (e.g., crude oil, refined oil, liquid water, and/or the like) along a ground surface from a first location to a second location.

The constructed pipeline may be deployed or installed in a subterranean area such as a trench. Alternatively, the constructed pipeline may be deployed or installed above ground onto a series of aboveground support structures provided therefor from the first location to the second location.

In the subterranean installation scenario, one or more trenching modules or machines are used for digging a trench for deploying the constructed pipeline. After pipeline deployment, one or more trench-filling modules are used for filling the trench with suitable material (e.g., earth).

In the aboveground installation scenario, necessary equipment may be used for erection of the series of aboveground support structures and installation of the continuous fluid-transmission pipeline thereonto.

Embodiments described hereinafter use the subterranean installation scenario as an example, although such embodiments may also be used for pipeline deployment on aboveground support structures.

The system disclosed herein integrates the pipeline-construction processes into a single automated or semi-automated machine and subsequently requires less operators and equipment with reduced environmental footprint in pipeline pipeline-construction, compared to conventional systems.

According to one aspect of this disclosure, there is provided a self-propelled semi-automated remote-controllable apparatus for sealably engaging sections of fluid transmission pipeline joints end-to-end thereby producing a continuous long-distance fluid transmission pipeline for installation between a first location for receiving therefrom a supply of a fluid and a second location for delivery thereto of the fluid.

In some embodiments, the system disclosed herein integrates at least a subset of a ditcher or a trenching machine, sidebooms, welding equipment, welding inspection equipment and/or instruments, weld repair, pipe coating, and cathodic protection processes into a single machine. The integration removes the need for multiple pieces of heavy equipment and personnel while constructing pipelines, thereby reducing the costs and the safety risks with reduced construction footprint that lowers the impact on the environment.

As those skilled in the art will appreciate, while the pipeline is preferably to be deployed along a straight line in a topographical space, the pipeline and the associated pipeline-construction trail 108 may have one or more laterally curved portions and/or uneven portions with changing elevations. Generally, these curved and/or uneven portions are of large radii, and may still be considered substantively straight portions. However, in some locations, the pipeline may need to have bent portions for a relatively sharp direction change. At such locations, the pipeline may be bent to the required curvature or alternatively, welded with an elbow or welding bend.

As will be described in more detail below, in some embodiments, the automated pipeline-construction system disclosed herein may be used for constructing substantively straight pipeline portions. In some other embodiments, the automated pipeline-construction system disclosed herein may be used for constructing both substantively straight pipeline portions and bent portions.

Herein, the term “pipeline joint” generally refers to a section of a pipe to be welded or otherwise coupled to a pipeline or a constructed pipeline.

The term “pipeline” and “constructed pipeline” refer to a length of pipe generally constructed by welding or otherwise coupling a plurality of pipeline joints in sequence. The pipeline or constructed pipeline may be processed and attached with necessary components such as one or more leak-detection cables comprising therealong sensors for detection of volatile and/or liquid fluid components.

In some embodiments, the pipeline joint and the constructed pipeline may be made of a suitable metal such as steel. In some other embodiments, the pipeline joint and the constructed pipeline may be made of other suitable materials such as plastic or a composite material.

Generally, the constructed pipeline may be used for transporting liquid phase or gas phase materials. For example, in some embodiments, the constructed pipeline may be used for transporting liquid-form hydrocarbon products such as crude oil, bitumen, liquefied natural gas (LNG), and/or the like; in some embodiments, the constructed pipeline may be used for transporting water, waste fluid, or the like; in some embodiments, the constructed pipeline may be used for transporting gas-phase natural gas.

In various embodiments, the pipeline joints and the pipeline constructed therefrom may have any suitable diameters. For example, in some embodiments, the pipeline joints and the pipeline constructed therefrom may have a diameter between about 4″ (i.e., 4 inches) to about 48″ (i.e., about 10.2 centimeters (cm) to about 122 cm). In some embodiments, the pipeline joints and the pipeline constructed therefrom may have a diameter between about 2″ to about 54″ (i.e., about 5 cm to about 137 cm).

A distal portion of the pipeline or constructed pipeline may be subsequently deployed into a trench with a proximal portion thereof maintained in a pipeline-construction vehicle for further pipeline construction by further welding or otherwise coupling the distal end of another pipeline joint to the proximal end of the pipeline or constructed pipeline. Herein, the adjacent distal end of the pipeline joint and proximal end of the constructed pipeline welded together or to be welded together is generally denoted as a “butt joint”. When welded, the butt joint may also be denoted as an “engaged joint”.

As will be described in more detail later, the pipeline or constructed pipeline is generally partially deployed into a trench provided therefor during a pipeline construction and deployment process, and is fully deployed into the trench when the pipeline construction and deployment process is completed.

According to one aspect of this disclosure, there is disclosed an automated remote-controllable pipeline construction and laying apparatus and system.

In some embodiments, the system comprises an automated robotic welding apparatus for production of continuous pipelines for underground and/or undersea installation.

In some embodiments, the automated pipeline-construction system disclosed herein may comprise:
one or more pipeline-racking vehicles arranged in series for storing a plurality of pipeline joints thereon (also referred to herein as a rolling chassis having a front section for receiving thereon a plurality of joints); and
a self-propelled pipeline-construction vehicle behind the one or more pipeline-racking vehicles 104 for receiving pipeline joints one-by-one from the one or more pipeline-racking vehicles and automatically coupling each received pipeline joint to the constructed pipeline through a construction process comprising steps of preparation, welding, inspection, re-welding (if needed), coating, instrumentation and cathodic protection (also referred to herein as a rolling chassis having a mid section and a rear section for housing thereon said construction, inspection, coating and protection equipment), and deployment of the constructed pipeline.

A computing structure controls the one or more pipeline-racking vehicles and the pipeline-construction vehicle to align them at least laterally and to synchronously move forward for deploying the constructed pipeline.

Each of the one or more pipeline-racking vehicles and the pipeline-construction vehicle may comprise a moving structure, and the computing structure may control the moving structures thereof for leveling the one or more pipeline-racking vehicles and the pipeline-construction vehicle.

In some embodiments, the automated pipeline-construction system disclosed herein may further comprise:
a self-propelled trenching module operating in front of the one or more pipeline-racking vehicles; and
a self-propelled trench-filling module operating behind the pipeline-construction vehicle.

Each of the pipeline-racking vehicles, pipeline-construction vehicle, trenching module, and trench-filling module may comprise an undercarriage with a motorized high-flotation weight-dispersing endless track drive assembly (e.g., at least two or more pairs of high-flotation weight-dispersing tracks) at each of its four corners to minimize the weight pressure exerted on the terrain by the individual vehicles/modules and by the entire system. Each of the motorized vehicles/modules is provided with devices and systems that will automatically level the work surface of the vehicle/module to maintain it parallel with the horizontal axis.

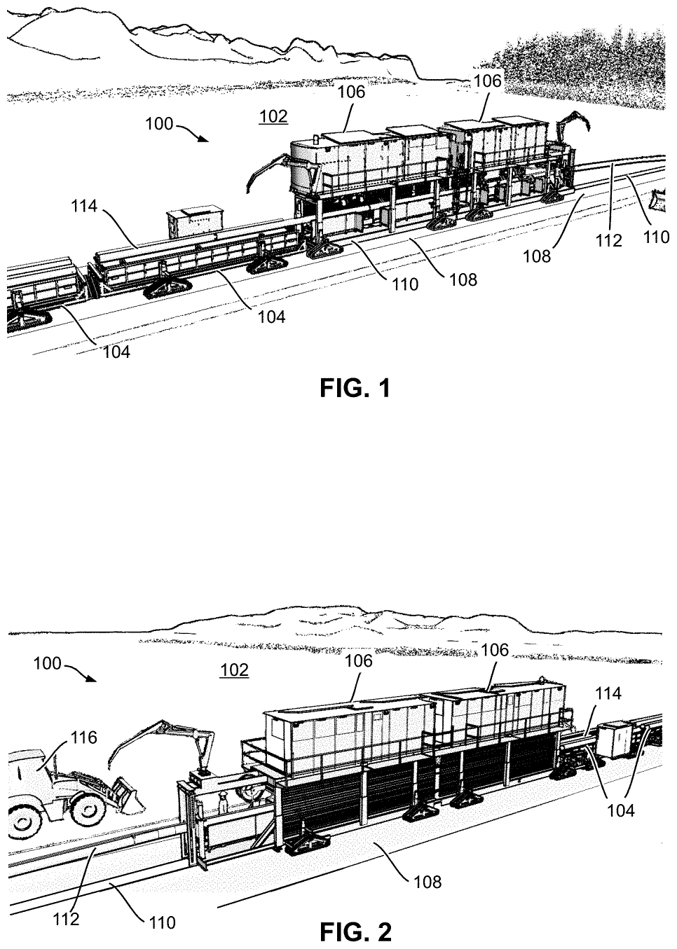

Turning now to FIGS. 1 and 2, an automated pipeline-construction system is shown and is generally identified using reference numeral 100. As shown, the automated pipeline-construction system 100 may be deployed in a pipeline-construction site 102 and comprise one or more pipeline-racking vehicles 104 and a pipeline-construction vehicle 106 movable along a pipeline-construction trail 108 having a ditch or trench 110 generally along a central axis thereof, for constructing the pipeline 112 on-site using a plurality of pipeline joints 114 and laying the constructed pipeline 112 into the trench 110. As shown in FIG. 2, the automated pipeline-construction system 100 may also comprise a plurality of utility vehicles 116 such as ditchers/trencher, Bobcats® (BOBCAT is a registered trademark of BOBCAT COMPANY of North Dakota, U.S.A.), forklifts, and/or the like for facilitating the construction of the pipeline 112.

The one or more pipeline-racking vehicles 104 are generally arranged in series in front of the pipeline-construction vehicle 106, and the vehicles 104 and 106 may be pivotably hitched or otherwise linked together for cooperation with each other. For example, FIG. 1 shows two pipeline-racking vehicles 104 in front of the pipeline-construction vehicle 106, and the three vehicles 104 and 106 are pivotably hitched together.

The pipeline-racking vehicle 104 is configured for receiving and storing pipeline joints 114 and selectively conveying the pipeline joints 114 therein one-by-one to the pipeline-construction vehicle 106 for pipeline construction after aligning the selected pipeline joint 114 with the one already in the pipeline-construction vehicle 106.

Herein, the term “alignment” may be used for describing the alignment of the pipeline-racking vehicle 104 and the pipeline-construction vehicle 106, in which the two vehicles 104 and 106 are substantively aligned at least along a horizontal plane (i.e., the longitudinal axes thereof are substantively in parallel) and the elevations thereof may or may not be aligned depending on the implementation). The alignment of the two vehicles 104 and 106 may not be highly precise.

The term “alignment” may be also used for describing the alignment of two pipeline joints 114 (in some embodiments, one of the pipeline joints 114 may be in the pipeline-racking vehicle 104 and the other may be in the pipeline-construction vehicle 106; in some other embodiments, both pipeline joints 114 may be in the pipeline-construction vehicle 106), in which the two pipeline joints 114 are precisely aligned in a three-dimensional (3D) space (i.e., the longitudinal axes thereof are precisely in parallel in the 3D space; in other words, the two pipeline joints 114 are longitudinally concentric).

The pipeline-racking vehicle 104 generally has a length equal to or longer than the typical length of pipeline joints 114. For example, in some embodiments, the automated pipeline-construction system may be designed for constructing pipelines using double random length (DRL) pipeline joints 114, such as for constructing pipelines with diameter greater than 2″ (i.e., 2 inches or 5 cm). The pipeline-racking vehicle 104 in these embodiments may have a length of about 13 meters (m) (i.e., about 43′). Such a pipeline-racking vehicle 104 may be denoted as a DRL pipeline-racking vehicle 104 hereinafter.

In some embodiments, the automated pipeline-construction system is design for constructing pipelines using single random length (SRL) pipeline joints 114, such as for constructing pipelines with diameter smaller than 2″ (i.e., 5 cm). The pipeline-racking vehicle 104 in these embodiments may have a length of about 8 m (i.e., about 26′). Such a pipeline-racking vehicle 104 may be denoted a SRL pipeline-racking vehicle 104 hereinafter.

In some embodiments, the width of the pipeline-racking vehicle 104 may be about 8′ to about 12′ (i.e., about 2.4 m to about 3.6 m).

Those skilled in the art will appreciate that in some embodiments, a DRL pipeline-racking vehicle 104 may also be used for carrying SRL pipeline joints 114.

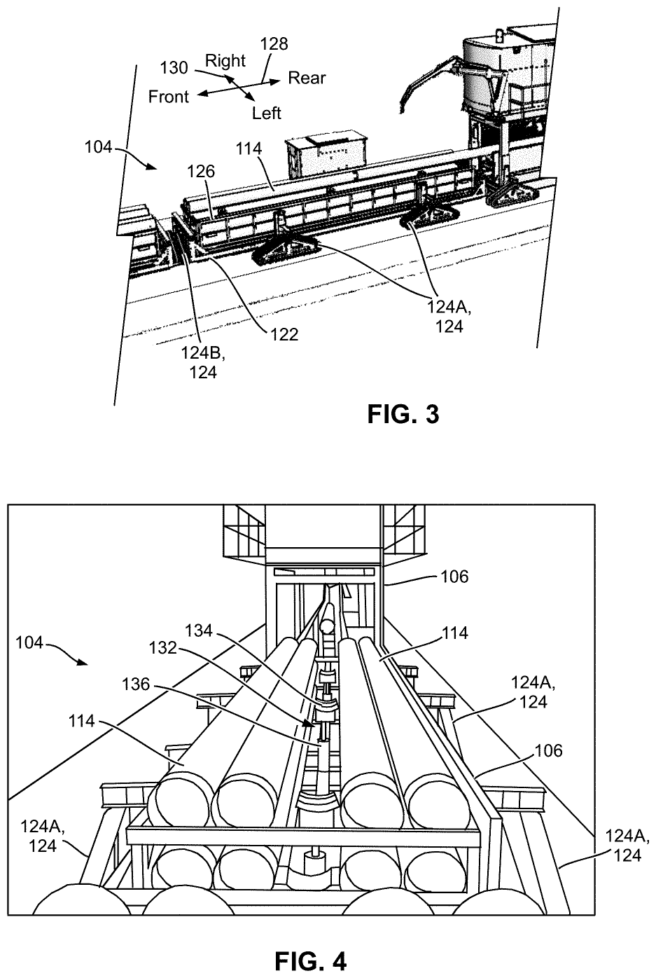

As shown in FIGS. 3 and 4, the pipeline-racking vehicle 104 in these embodiments comprises a rolling chassis 122 coupled to a moving structure 124 and receiving thereon a container 126 in the form of a cage. The cage 126 receives therein a plurality of pipeline joints 114 stacked together and arranged along a longitudinal direction 128 for conveying or feeding pipeline joints 114 one-by-one to the pipeline-construction vehicle 106 or the pipeline-racking vehicle 104 at a rear side thereof.

The moving structure 124 of the pipeline-racking vehicle 104 allows the pipeline-racking vehicle 104 to be driven by the pipeline-construction vehicle 106 to move forward or rearward. The moving structure 124 also allows the substantive alignment of the pipeline-racking vehicle 104 to the pipeline-construction vehicle 106 at least along a horizontal plane (i.e., horizontal alignment thereof).

In these embodiments, the moving structure 124 of the pipeline-racking vehicle 104 comprises a first set of triangular-shaped track assemblies 124A arranged on the laterally opposite sides of the pipeline-racking vehicle 104 for moving the pipeline-racking vehicle 104 forwardly or rearwardly along the longitudinal direction 128.

The moving structure 124 also comprises a second set of triangular-shaped track assemblies 124B arranged on longitudinally opposite sides of the pipeline-racking vehicle 104 for moving the pipeline-racking vehicle 104 left or right along the lateral direction 130 for orienting the pipeline-racking vehicle 104 to substantively horizontally align with the pipeline-construction vehicle 106 to facilitate the conveying of the pipeline joints 114 thereinto.

In some embodiments, the moving structure 124 may also allow height adjustment of the chassis 122 to adapt to the uneven terrain of the pipeline-construction site 102 and substantively vertically align the pipeline-racking vehicle 104 with the pipeline-construction vehicle 106 (described later).

As shown in FIG. 4, the pipeline-racking vehicle 104 also comprises a conveying structure 132 for lifting a pipeline joint 114, performing fine height-adjustment thereof, and conveying the lifted pipeline joint 114 into the pipeline-construction vehicle 106.

In these embodiments, the conveying structure 132 of the pipeline-racking vehicle 104 is in the form of a plurality of telescopic lifting post (also identified using reference numeral 132) arranged at the lateral center thereof and distributed along the longitudinal direction 128. Each lifting post 132 in these embodiments comprises a concave-shaped top surface 134 with a curvature thereof matching that of the pipeline joint 114 for securely engaging the pipeline joint 114 and preventing the pipeline joint 114 from falling off from a lateral side. Each lifting post 132 also comprises a lifting mechanism 136 such as a hydraulic post coupled to a motor (not shown) for extending the lifting post 132 through the bottom of the cage 126 to lift a pipeline joint 114 and adjusting the height thereof to align the lifted pipeline joint 114 with the pipeline-construction vehicle 106.

When a pipeline joint 114 is lifted by the conveying structure 132 with height thereof adjusted to a suitable elevation, one or more driving rollers (not shown) may engage the lifted pipeline joint 114 (such as engaging the bottom thereof) for moving it rearwardly into the pipeline-construction vehicle 106.

In some embodiments, the conveying structure 132 may also be laterally movable for laterally fine adjustment of the alignment of the lifted pipeline joint 114.

The pipeline-construction vehicle 106 receives pipeline joints 114 from the adjacent pipeline-racking vehicle 104 and constructs the pipeline 112 using the received pipeline joints 114. The pipeline-construction vehicle 106 generally has a length longer than the typical length of pipeline joints 114. For example, in some embodiments, the automated pipeline-construction system is design for constructing pipelines using DRL pipeline joints 114, such as for constructing pipelines with diameter greater than 2″ (i.e., 2 inches; 3.6 cm). The pipeline-construction vehicle 106 in these embodiments may have a length about 50′ (i.e., about 15 m). Such a pipeline-racking vehicle 104 may be denoted a DRL pipeline-construction vehicle 106 hereinafter.

In some embodiments wherein the automated pipeline-construction system is design for constructing pipelines using SRL pipeline joints 114, such as for constructing pipelines with diameter smaller than 2″ (i.e., 5 cm), the pipeline-construction vehicle 106 may have a length of about 8 m (i.e., about 26′). Such a pipeline-construction vehicle 106 may be denoted a SRL pipeline-construction vehicle 106 hereinafter.

In some embodiments, the width of the pipeline-construction vehicle 106 may be about 8′ to about 12′ (i.e., about 2.4 m to about 3.6 m).

Those skilled in the art will appreciate that in some embodiments, a DRL pipeline-construction vehicle 106 may also be used for constructing pipelines using SRL pipeline joints 114.

Alternatively, a SRL pipeline-construction vehicle 106 may also be used for constructing pipelines using DRL pipeline joints 114 in some embodiments. In these embodiments, the pipeline-racking vehicle 104 and the pipeline-construction vehicle 106 closely collaborate for alignment of pipeline joints 114.

Herein, the pipeline-construction vehicle 106 is configured for receiving pipeline joints 114 from the pipeline-racking vehicle 104, welding the butt joint of adjacent pipeline joints 114 to form the constructed pipeline 112, inspecting the circumferential integrity of each welded butt-joint and if necessary, re-welding a butt joint that does not pass inspection, shrink-wrapping each welded butt-joint with a fluid-impermeable and/or a gas-impermeable material, securing a continuous and endless leak-detection cable to the outer surface of the constructed pipeline 112, and then laying the constructed pipeline 112 into the trench 110.

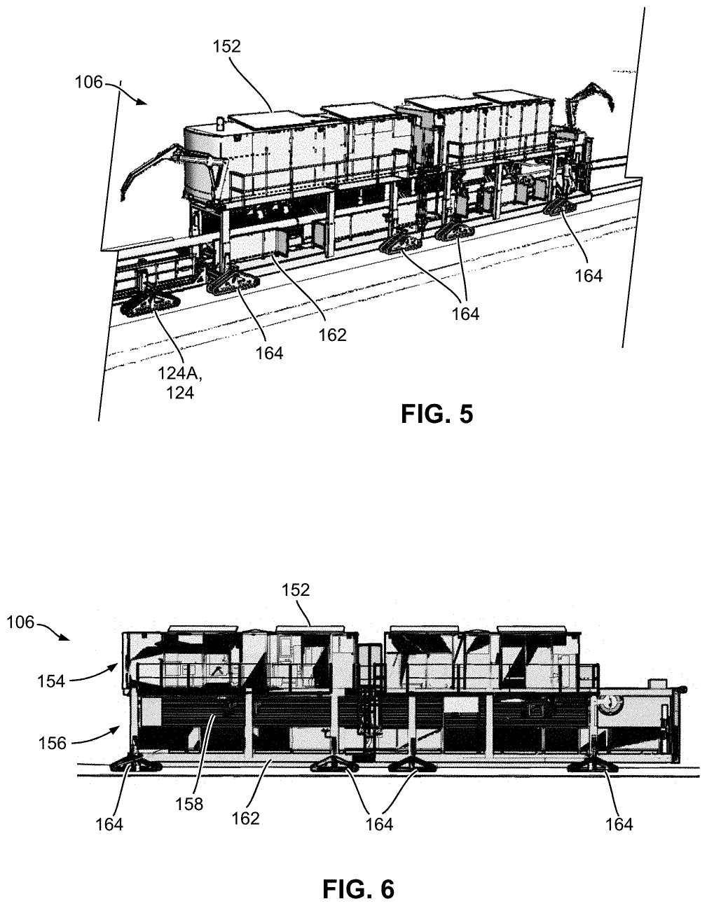

The pipeline-construction vehicle 106 in these embodiments is in the form of a self-propelled train and comprises a housing 152 secured on a platform or rolling chassis 162 which is in turn coupled to a moving structure 164. The housing 152 may comprise one or more stories or levels. For example, in the embodiments shown in FIGS. 5 and 6, the housing 152 comprises two levels with an upper level having a superstructure 154 mounted thereon, integrated with, or otherwise coupled to a lower level 156. The upper level 154 is configured for housing operator cabins, control boxes, motive power components such as one or more internal-combustion engines, power sources, and/or the like. The lower level 156 is configured for receiving pipeline joints 114 and assembling the continuous pipeline 112. The height of each of the upper and lower levels 154 and 156 may be about 8′ (i.e., about 2.4 m). However, those skilled in the art will appreciate that, in various embodiments, the upper and lower levels 154 and 156 may be any suitable, desired, or required heights.

In these embodiments, the lower level 156 of the housing 152 is substantively a framework comprising necessary bottom elements for engaging therewith the rolling chassis 162. For safety considerations, the lower level 156 may additionally comprise curtains 158 or shields on at least one of the laterally opposite sides thereof.

In some embodiments, the one or more internal-combustion engines may not be located on the upper level 154 and instead may be located in the lower level 156. Similarly, power sources in some embodiments may not be located on the upper level 154 and instead may be located in the lower level 156.

Similar to that of the pipeline-racking vehicle 104, the moving structure 164 of the pipeline-construction vehicle 106 comprises a plurality of (e.g., at least two or more pairs of) triangular-shaped track assemblies (also identified using reference numeral 164) arranged on the laterally opposite sides of the pipeline-construction vehicle 106. The track assemblies 164 are driven by or a source of motive power such as an internal-combustion engine via a transmission (not shown) for moving the pipeline-construction vehicle 106 forwardly or rearwardly along the longitudinal direction 128.

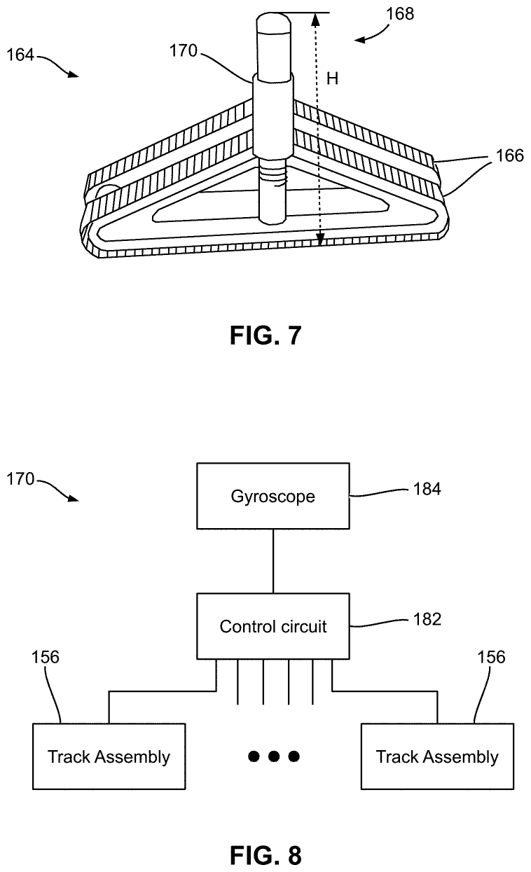

FIG. 7 shows a track assembly 164. As shown, each track assembly 164 comprises one or more motorized high-flotation weight-dispersing endless tracks 166 engaging a plurality of wheels and driven sprockets (not shown) for being driven by an engine (not shown) to move forward and backward and for lowering the weight pressure exerted on the terrain. The one or more endless tracks 166 are coupled to a suspension structure 168 having one or more telescopic hydraulic cylinders 170 vertically extendable and retractable for adjusting the height or elevation of the platform 162 coupled thereto. When the telescopic hydraulic cylinders 170 are fully extended, the track assembly 164 in these embodiments has a maximum height H of 1.2 m (i.e., about 4′).

In these embodiments, the telescopic hydraulic cylinders 170 of each track assembly 164 are coupled to a height-adjustment actuator (not shown) and are independently controllable. FIG. 8 is a schematic diagram showing a control system for adjusting the track assemblies 164.

As shown, the pipeline-construction vehicle 106 comprises a control circuit 182 in communication with one or more suitable sensors 184 such as one or more gyroscopes installed on the platform 162 for obtaining the level information thereof. Based on the output of the gyroscopes 184, the control circuit 182 commands the height-adjustment actuator of the telescopic hydraulic cylinders 170 of each track assembly 164 to maintain the leveling of the platform 162 within a predefined range for alleviating the stress that may be otherwise applied to the pipeline joints thereon and for preventing pipeline joints from unwanted movement due to gravity.

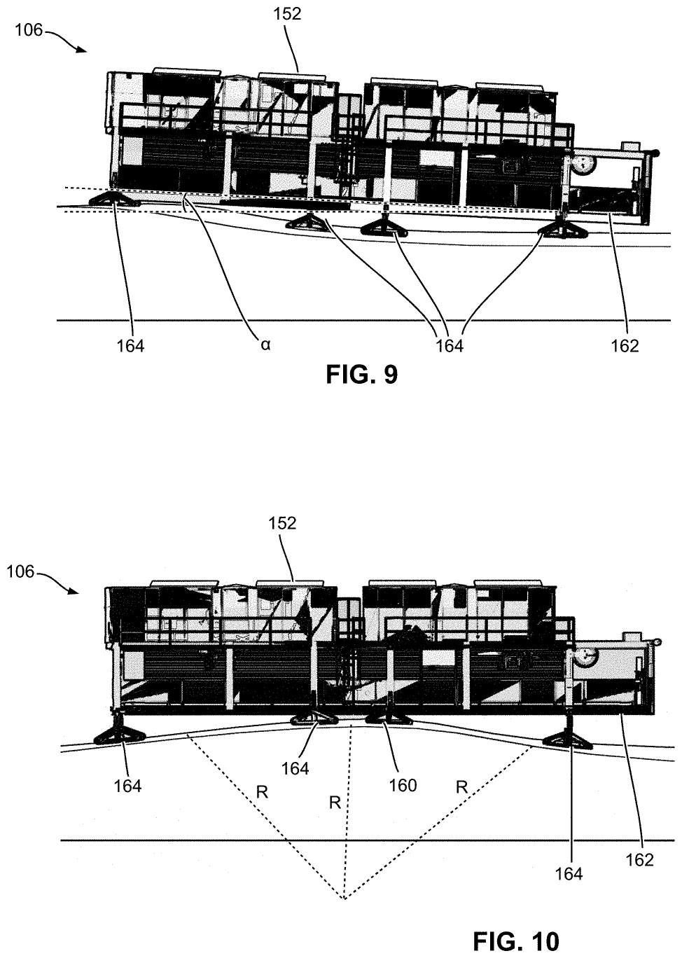

For example, as shown in FIG. 9, by independently adjusting the height of each track assembly 164, the control circuit 182 of the pipeline-construction vehicle 106 may adapt to a longitudinally sloped terrain and automatically maintain the longitudinal slope of the platform 162, measured by the angle α between the longitudinal axis of the platform 162 and a horizontal plane, to be within a predefined longitudinal angular range, when at least one of the track assemblies 164 is at its maximum or minimum height.

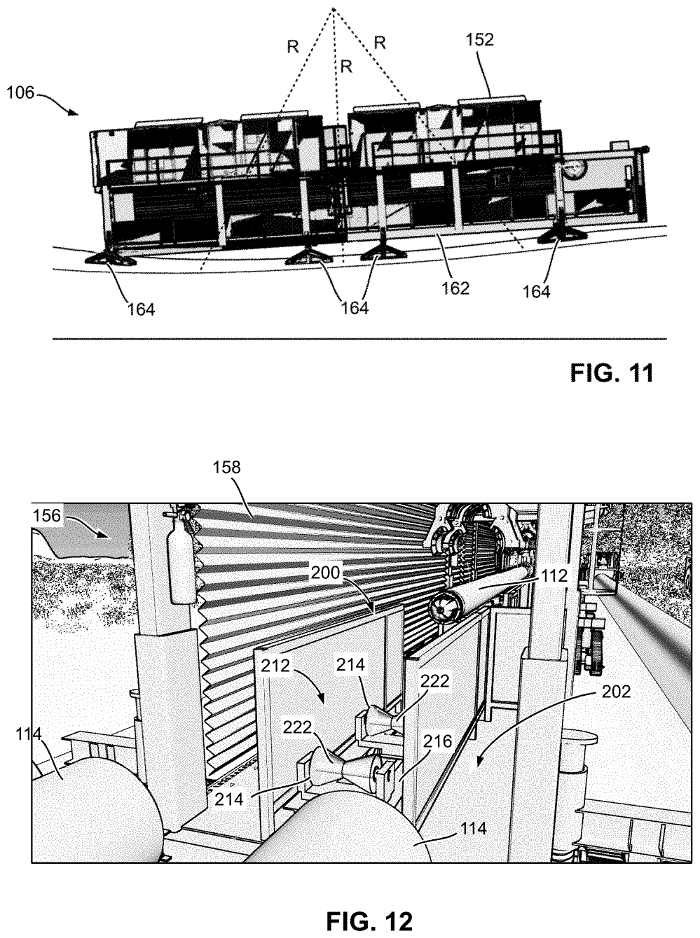

In some embodiments as shown in FIGS. 10 and 11, the control circuit 182 of the pipeline-construction vehicle 106 may independently adjust the height of each track assembly 164 to automatically adapt to a longitudinally uneven terrain of a longitudinal length greater than or equal to that of the pipeline-construction vehicle 106 and with a grading having a radius R of curvature less than or equal to a predefined threshold radius Rₜₕ, i.e., R≤Rₜₕ, such that the longitudinal slope of the platform 162 is within the predefined longitudinal angular range, when at least one of the track assemblies 164 is at its maximum or minimum height. In some embodiments, the predefined threshold radius Rₜₕ is about 100 m (i.e., about 328′).

In some embodiments, the control circuit 182 of the pipeline-construction vehicle 106 may also independently adjust the height of each track assembly 164 to automatically maintain the lateral slop of the platform 162 to be within a predefined lateral angular range, when at least one of the track assemblies 164 is at its maximum or minimum height.

As described above, the housing 152 of the pipeline-construction vehicle 106 is a two-level structure comprising an upper level 154 and a lower level 156. The lower level 156 comprises necessary devices for constructing the pipeline 112 using the received pipeline joints 114.

FIG. 12 is a perspective view of a portion of the lower level 156 of the housing 152. As shown, the lower level 156 comprises an operation zone 200 along a longitudinal axis thereof and at least one operator's walkway 202 adjacent thereto. As described above, the lower level 156 of the housing 152 may comprise curtains 158 or shields on at least one of the laterally opposite sides thereof for safety considerations.

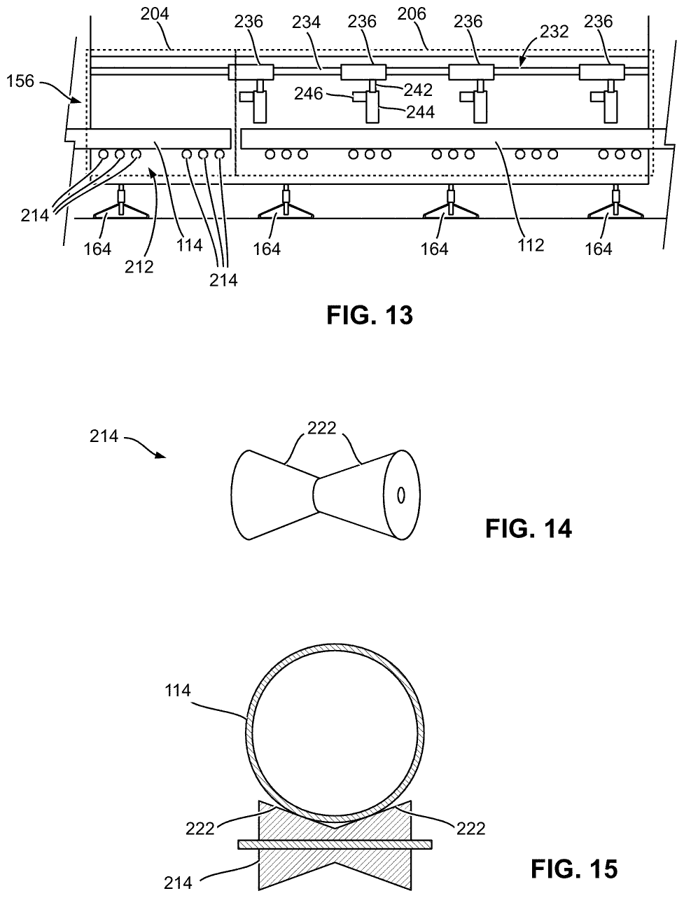

As shown in FIG. 13, the lower level 156 of the housing 152 may be partitioned into two areas, including a first alignment area 204 for conveying the received pipeline joint 114 and a second construction area 206 for constructing the pipeline 112.

Referring to FIGS. 12 and 13, the alignment area 204 comprises a conveyance mount or conveying structure 212 in the operation zone 200 having a plurality of laterally horizontally oriented rollers 214 longitudinally distributed on a lifting structure 216 such as a structure having a plurality of telescopic hydraulic cylinders (not shown) that are vertically extendable and retractable for adjusting the height of the conveying structure 212.

As shown in FIGS. 14 and 15, each roller 214 has a shape similar to two frustums coupled at the smaller ends and comprises a concave circumferential surface 222 tapering from laterally opposite sides towards the center thereof for supporting the pipeline joint 114 thereon, laterally aligning the pipeline joint 114 with the pipeline 112 in the construction area 206, and restricting the lateral movement of the aligned pipeline joint 114.

The construction area 206 of the lower level 156 of the housing 152 comprises a conveyance mount or conveying structure similar to the conveying structure 212 in the alignment area 204 and an overhead travelling crane 232 having one or more runway beams 234 with a plurality of tool assemblies 236 movably coupled thereon.

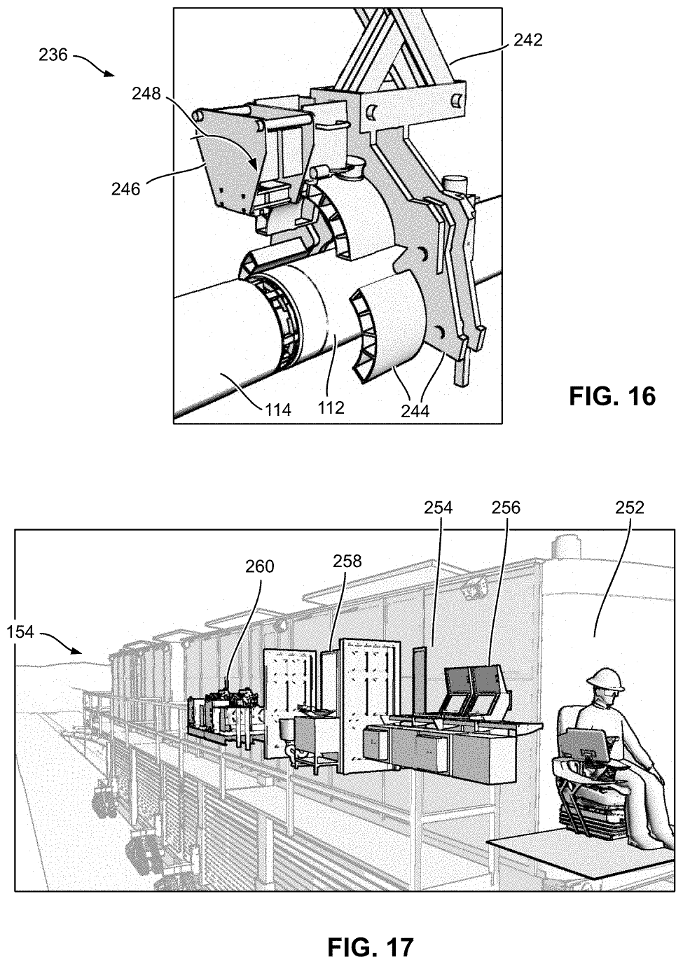

FIG. 16 shows an example of a tool assembly 236 in the form of an automatic welding assembly. As shown, the tool assembly 236 in these embodiments substantively comprises a hanging structure 242 with the upper end longitudinally movably coupled to the runway beams 234 thereabove (not shown). The hanging structure 242 is vertically extendable and retractable with the lower end thereof coupled to a clamp structure 244 and a pipeline-construction tool 246. The pipeline-construction tool 246 is positioned on a longitudinal side of the clamp structure 244 and is rotatable about an axis of the aligned pipeline 112 and pipeline joint 114.

As will be described in more detail later, in operation, the hanging structure 242 may extend the clamp structure 244 and pipeline-construction tool 246 downwardly about the constructed pipeline 112. The clamp structure 244 clamps to the pipeline 112 or the pipeline joint 114 to locate the pipeline-construction tool 246 at a suitable position adjacent the pipeline 112 and/or pipeline joint 114. Then, the pipeline-construction tool 246 may be controllably operated while rotating about the pipeline 112 and/or pipeline joint 114.

In some embodiments, the upper level 154 of the housing 152 may be used for housing therein equipment and systems for remote control by an operator, to monitor and adjust the pipeline construction activities ongoing in the lower level 156 thereof.

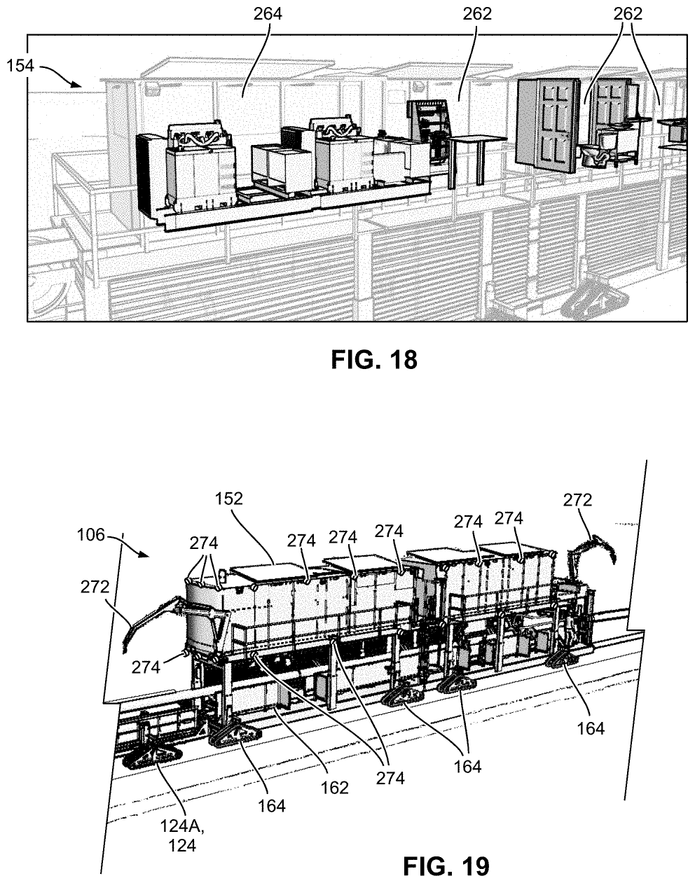

As shown in FIGS. 17 and 18, the upper level 154 of the housing 152 comprises a monitor-room module 252 in the form of a portable-type office cabin located at the front side thereof. The monitor-room module 252 comprises windows and necessary devices such as one or more monitoring computing devices (e.g., computer terminals) having one or more microprocessors and one or more computer screens and executing suitable pipeline-construction monitoring programs for one or more operators to control and monitor various aspects of the pipeline construction such as:
the direction and speed of trenching by a self-propelled trenching module (described later);
the direction and speed of movement of the pipeline-racking vehicle 104 for ensuring suitable feeding of the pipeline joints 114 from the pipeline-racking vehicle 104 to the pipeline-construction vehicle 106;
the direction and speed of movement of the pipeline-construction vehicle 106 for ensuring suitable delivery of constructed pipeline 112 from the rear side of the pipeline-construction vehicle 106 into the middle of the trench 110;
the leveling of the pipeline-racking vehicle 104 and the pipeline-construction vehicle 106;
the selection of a pipeline joint 114 from the pipeline-racking vehicle 104, the delivery process of the selected pipeline joint 114 into the pipeline-construction vehicle 106 to abut the end of the constructed pipeline 112 therein for further pipeline construction;
the alignment between the pipeline-racking vehicle 104 and the pipeline-construction vehicle 106 and the alignment between various components and devices of the pipeline-racking vehicle 104 and the pipeline-construction vehicle 106;
the pipeline-construction process (described in more detail later), including (i) the automated robotic welding and inspection of a butt joint between the pipeline joint 114 and the pipeline 112, (ii) welding inspection, (iii) welding repairing as needed, (iv) shrink wrapping of the welded butt-joint, (v) installation of a continuous and endless leak-detection cable to the outer surface of the constructed pipeline 112, and (vi) deployment of the constructed pipeline 112 into the trench 110; and
communication with other computing devices including computing devices remote to the pipeline-construction site 102.

In these embodiments, the upper level 154 of the housing 152 also comprises a control-room module 254 receiving therein one or more control stations 256 for controlling various aspects of the pipeline construction, a rest-room module 258, a maintenance-room module 260, one or more office modules 262, and a power-generator module 264 having one or more electrical-power generators for generating power for various components and devices such as the pipeline-racking vehicle 104, the pipeline-construction vehicle 106, and the devices thereon.

In some embodiments, the one or more internal-combustion engines are in communication with the one or more electrical-power generators, and the electrical-power generators are in motive communication with the rolling chassis.

In some embodiments, the one or more internal-combustion engines may comprise one or more main engines for powering the pipeline-racking vehicle 104, the pipeline-construction vehicle 106, and/or various other devices, and one or more additional engines as backup for the main engines.

In some embodiments, the electrical-power generators are in communication with a plurality of electrical-power storage batteries housed in the pipeline-racking vehicle 104 and/or the pipeline-construction vehicle 106 (e.g., in the rolling chassis and/or the superstructure).

In some embodiments, the plurality of electrical-power storage batteries may be in motive communication with the rolling chassis.

In some embodiments, the pipeline-construction vehicle 106 may additionally comprise an apparatus in communication with the one or more internal-combustion engines to capture excess heat generated therefrom and to generate electrical power from the excess heat whereby the electrical power is transmissible as motive power to the rolling chassis and/or in communication with the plurality of electrical-power storage batteries.

In some embodiments, the motive power components may be housed on a separate rolling chassis that is demountably engaged with the pipeline-construction vehicle and the pipeline-racking vehicle. For example, the rolling chassis with the motive power components may be positioned between and demountably engaged with the pipeline-racking vehicle and the pipeline-construction vehicle, and may be controllably operated to concurrently provide motive power to operate the high-flotation weight-dispersing tires or tracks provided for both vehicles. Alternatively, the pipeline-construction vehicle may be positioned between and demountably engaged with the pipeline-racking vehicle and the rolling chassis with the motive power components housed thereon, and the motive power may be controllably delivered from the rolling chassis to the pipeline-construction vehicle and the pipeline-racking vehicle to operate the high-flotation weight-dispersing tires or tracks provided for both vehicles.

As shown in FIG. 19, in some embodiments, the pipeline-construction vehicle 106 also may also comprise one or more cranes 272 mounted at suitable locations of the upper level 154 such as two cranes 272 mounted at the front and rear sides of the upper level 154 of the pipeline-construction vehicle 106, respectively, for performing pipeline-construction related tasks.

In these embodiments, the pipeline-construction vehicle 106 may further comprise a plurality of lights 274 on the housing 152 for illumination during dark time such as nights. A first set of lights 274 may be installed about an upper edge of the upper level 154 for illuminating a large area about the pipeline-construction vehicle 106. A second set of lights 274 may be installed about an upper edge of the lower level 156 or about a lower edge of the upper level 154 for enhanced illumination of an area adjacent the pipeline-construction vehicle 106.

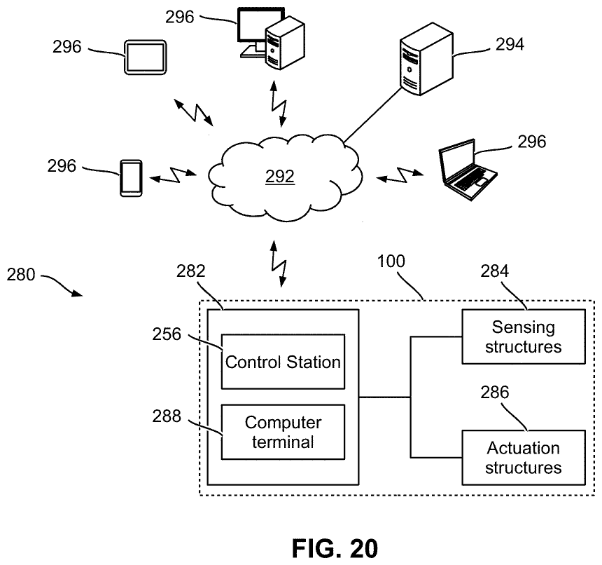

The automated pipeline-construction system 100 comprises and uses a control subsystem for automating pipeline construction. FIG. 20 is a schematic diagram of the control subsystem 280.

As shown, the control subsystem 280 comprises a computing structure 282 functionally coupled to a plurality of sensing structures 284 and actuation structures 286 distributed on the pipeline-racking vehicle 104, the pipeline-construction vehicle 106, and other devices and/or vehicles as needed, for collecting suitable data related to construction and for deployment of pipelines and automatically constructing and deploying pipelines based on collected data.

The computing structure 282 of the automated pipeline-construction system 100 may be functionally interconnected to a network 292, such as the Internet, a local area network (LAN), a wide area network (WAN), a metropolitan area network (MAN), and/or the like, via suitable wireless network connections although in some situations, wired network connection between the computing structure 282 and the network 292 may also be available.

The network 292 may also be functionally interconnected to a plurality of computing devices such as one or more servers 294 and one or more client computing devices 296 such as desktop computers, laptop computers, tablets, smartphones, Personal Digital Assistants (PDAs), and the like. Thus, the computing structure 282 of the automated pipeline-construction system 100 may be in communication with the computing devices 294 and 296 through the network 292 as needed.

The computing structure 282 in these embodiments comprises the control station 256 and the one or more monitoring computing devices 288 in the monitor-room module 252. The sensing structures 284 may comprise any necessary sensors (e.g., gyroscopes, accelerometers, barometers, light sensors, and/or the like), data receivers, and the like. The actuation structures 286 may comprise any necessary devices, components, and subsystems for pipeline construction and deployment such as engines, motors, servos, welding tools, sanding tools, heating tools, pipeline inspection tools, coating tools, and/or the like.

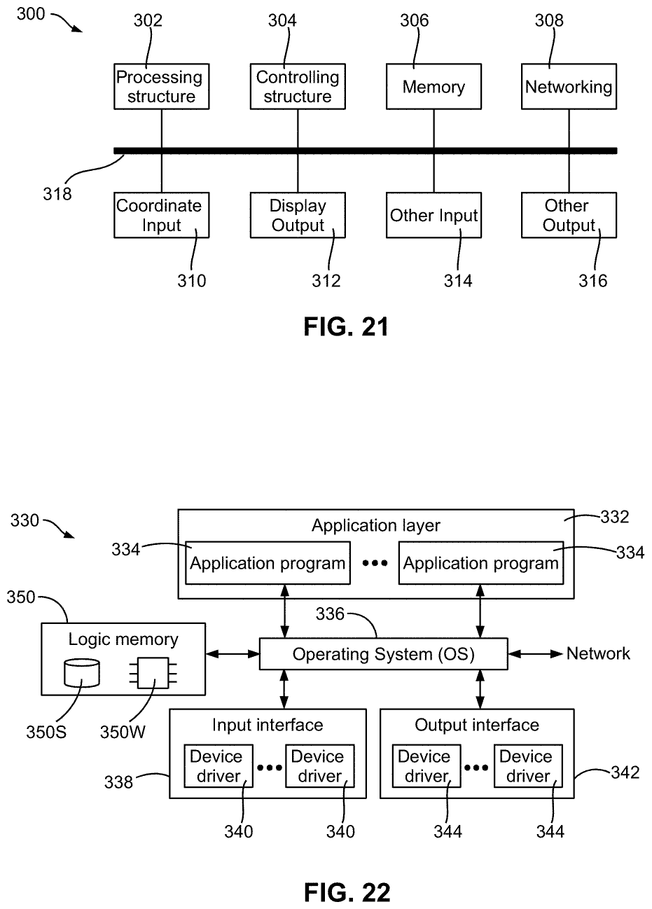

FIG. 21 shows the hardware structure 300 of the monitoring computing device 288. As shown, the monitoring computing device 288 comprises a processing structure 302, a controlling structure 304, one or more non-transitory computer-readable memory or storage devices 306, a networking interface 308, coordinate input 310, display output 312, and other input and output modules 314 and 316, all functionally interconnected by a system bus 318.

The processing structure 302 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, or the like.

The controlling structure 304 comprises one or more controlling circuits, such as graphic controllers, input/output chipsets and the like, for coordinating operations of various hardware components and modules of the monitoring computing device 288.

The memory 306 comprises a plurality of memory units accessible by the processing structure 302 and the controlling structure 304 for reading and/or storing data, including input data and data generated by the processing structure 302 and the controlling structure 304. The memory 306 may be volatile and/or non-volatile, non-removable or removable memory such as RAM, ROM, EEPROM, solid-state memory, hard disks, CD, DVD, flash memory, or the like. In use, the memory 306 is generally divided into a plurality of portions for different use purposes. For example, a portion of the memory 306 (denoted as storage memory herein) may be used for long-term data storing, for example, for storing files or databases. Another portion of the memory 306 may be used as the system memory for storing data during processing (denoted as working memory herein).

The networking interface 308 comprises one or more networking modules for connecting to other computing devices or networks through the network 292 by using suitable wired or wireless communication technologies such as Ethernet, WI-FI® (WI-FI is a registered trademark of Wi-Fi Alliance, Austin, Tex., USA), BLUETOOTH® (BLUETOOTH is a registered trademark of Bluetooth Sig Inc., Kirkland, Wash., USA), ZIGBEE® (ZIGBEE is a registered trademark of ZigBee Alliance Corp., San Ramon, Calif., USA), 3G, 4G and/or 5G cellular telecommunications technologies, and/or the like. In some embodiments, parallel ports, serial ports, USB connections, optical connections, or the like may also be used for connecting other computing devices or networks although they are usually considered as input/output interfaces for connecting input/output devices.

The coordinate input 310 comprises one or more input modules for one or more users to input coordinate data, such as touch-sensitive screen, touch-sensitive whiteboard, trackball, computer mouse, touch-pad, or other human interface devices (HID) and the like. The coordinate input 310 may be a physically integrated part of the monitoring computing device 288 (for example, the touch-pad of a laptop computer or the touch-sensitive screen of a tablet), or may be a device physically separate from, but functionally coupled to, other components of the monitoring computing device 288 (for example, a computer mouse). The coordinate input 310, in some implementation, may be integrated with the display output 312 to form a touch-sensitive screen or touch-sensitive whiteboard.

The display output 312 comprises one or more display modules for displaying images, such as monitors, LCD displays, LED displays, projectors, and the like. The display output 312 may be a physically integrated part of the monitoring computing device 288 (for example, the display of a laptop computer or tablet), or may be a display device physically separate from but functionally coupled to other components of the monitoring computing device 288 (for example, the monitor of a desktop computer).

The monitoring computing device 288 may also comprise other input 314 such as keyboards, microphones, scanners, cameras, Global Positioning System (GPS) component, and/or the like. The monitoring computing device 288 may further comprise other output 316 such as speakers, printers and/or the like.

The system bus 318 interconnects various components 302 to 316 enabling them to transmit and receive data and control signals to and from each other.

Generally, the hardware structures of the server 294 and the client computing devices 296 are similar to the hardware structure 300 of the monitoring computing device 288. Moreover, the control station 256 may also have a similar hardware structure as shown in FIG. 21 and described above. However, in various embodiments, the control station 256 may be specialized for industrial use and for adapting to industrial environment. For example, compared to general-purpose computing devices, the control station 256 may comprise more electromechanical components, implement software programs as firmware programs, have specialized design for fast or even real-time response, and have specialized design for combatting noise, vibration, impact, dust, and the like and providing enhanced reliability.

Moreover, the control station 256 may be simplified as needed compared to general-purpose computing devices. For example, in some embodiments, the control station 256 may not comprise a networking interface 308, coordinate input 310, and/or display output 312.

FIG. 22 shows a simplified software architecture 330 of the monitoring computing device 288. The software architecture 330 comprises an application layer 332, an operating system 336, an input interface 338, an output interface 342, and a logic memory 350. The application layer 332, operating system 336, input interface 338, and output interface 342 are generally implemented as computer-executable instructions or code in the form of software code or firmware code stored in the logic memory 350 which may be executed by the processing structure 302.

The application layer 332 comprises one or more application programs 334 executed by or run by the processing structure 302 for performing various tasks.

The operating system 336 manages various hardware components of the monitoring computing device 288 via the input interface 338 and the output interface 342, manages the logic memory 350, and manages and supports the application programs 334. The operating system 336 is also in communication with other computing devices (not shown) via the network 292 to allow application programs 334 to communicate with those running on other computing devices. As those skilled in the art will appreciate, the operating system 336 may be any suitable operating system such as MICROSOFT® WINDOWS® (MICROSOFT and WINDOWS are registered trademarks of the Microsoft Corp., Redmond, Wash., USA), APPLE® OS X, APPLE® iOS (APPLE is a registered trademark of Apple Inc., Cupertino, Calif., USA), Linux, ANDROID® (ANDROID is a registered trademark of Google Inc., Mountain View, Calif., USA), or the like.

The input interface 338 comprises one or more input device drivers 340 managed by the operating system 336 for communicating with respective input devices including the coordinate input 310 and other input module 314. The output interface 342 comprises one or more output device drivers 344 managed by the operating system 336 for communicating with respective output devices including the display output 312 and other output module 316. Input data received from the input devices via the input interface 338 is sent to the application layer 332, and is processed by one or more application programs 334. The output generated by the application programs 334 is sent to respective output devices via the output interface 342.

The logical memory 350 is a logical mapping of the physical memory 306 for facilitating the application programs 334 to access. In this embodiment, the logical memory 350 comprises a storage memory area (350S) that may be mapped to a non-volatile physical memory such as hard disks, solid-state disks, flash drives, and the like, generally for long-term data storage therein. The logical memory 350 also comprises a working memory area (350W) that is generally mapped to high-speed, and in some implementations volatile, physical memory such as RAM, generally for application programs 334 to temporarily store data during program execution. For example, an application program 334 may load data from the storage memory area 350S into the working memory area 350W, and may store data generated during its execution into the working memory area 350W. The application program 334 may also store some data into the storage memory area 350S as required or in response to a user's command.

Generally, the software structures of the server 294 and the client computing devices 296 are similar to the software structure 330 of the monitoring computing device 288. Moreover, the control station 256 may also have a similar software structure as shown in FIG. 22 and described above. However, in various embodiments, the control station 256 may be specialized for industrial use and for adapting to industrial environment. For example, the control station 256 may comprise a real-time OS 336 suitable for processing input data and generate response thereto in real-time. In some embodiments, the control station 256 may not comprise an OS 336. Rather, the control station 256 may comprise a bootstrap or bootloader for managing various hardware, firmware, and software components.

As those skilled in the art will appreciate, the monitoring computing device 288, the control station 256, the server 294, and the client computing devices 296 may have different operating systems in some embodiments, or may all have the same operating system in some other embodiments.

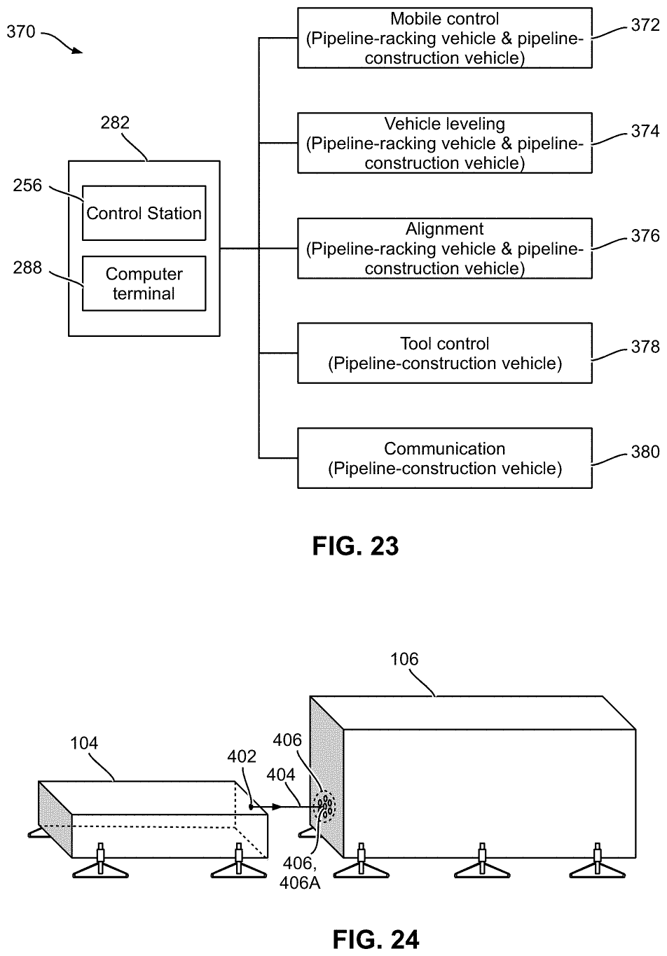

With the collaboration of the sensing structures 284 and the actuation structures 286, the computing structure 282 may automatically perform a plurality of functions for pipeline construction and deployment. FIG. 23 shows the function structure 370 of the control subsystem 280.

As shown, the computing structure 282 may automatically perform a plurality of functions during pipeline construction and deployment. The functions may be classified into the a plurality of categories including (a) mobile control 372, (b) vehicle leveling 374, (c) alignment 376, (d) tool control 378, and (e) communication 380.

(A) Mobile Control 372

In some embodiments, the sensing structure 284 may comprise one or more suitable speed sensors such as tachometers, active speed sensors (for example Hall-effect digital speed sensors, Hall-effect digital speed and direction sensors, digital magnetic speed sensors, and/or the like), passive variable reluctance speed (VRS) magnetic speed sensors, and/or the like on one or more vehicles of the automated pipeline-construction system 100 such as the pipeline-racking vehicle 104 and the pipeline-construction vehicle 106, and optionally the self-propelled trenching module, for measuring the speeds thereof. In some embodiments, the sensing structure 284 may also comprise one or more accelerometers on one or more vehicles of the automated pipeline-construction system 100 for measuring the acceleration and/or deceleration thereof.

The computing structure 282 may analyze the measurements obtained from the speed sensors and/or the accelerometers and automatically control the movement of the one or more vehicles of the automated pipeline-construction system 100 for ensuring successful pipeline construction and deployment.

For example, the computing structure 282 may use the measurements obtained from the speed sensors and/or the accelerometers and automatically control the pipeline-racking vehicle 104 and the pipeline-construction vehicle 106 to move at the same speed and/or along the same direction to ensure the pipeline joints 114 to smoothly feed from the pipeline-racking vehicle 104 to the pipeline-construction vehicle 106 at a controlled speed to facilitate the construction of the pipeline 102.

As another example, the computing structure 282 may use the measurements obtained from the speed sensors and/or the accelerometers and automatically control the pipeline-racking vehicle 104 and the pipeline-construction vehicle 106 to move at a suitable speed and/or along a suitable direction to ensure the constructed pipeline 102 is properly deployed in the trench 110 in a controlled manner and without bearing excessive stress and torsion.

Still as another example, the computing structure 282 may use the measurements obtained from the speed sensors and/or the accelerometers and automatically control the self-propelled trenching module to dig the trenching at a suitable speed to match that of the pipeline deployment.

(B) Vehicle leveling 374

In some embodiments, the sensing structure 284 may comprise one or more suitable leveling sensors such as gyroscopes, tilt sensors, inclinometers, position sensors, and/or the like on the pipeline-racking vehicle 104 and the pipeline-construction vehicle 106 for measuring the leveling thereof (e.g., the longitudinal and/or lateral tilting angles thereof).

The computing structure 282 may analyze the measurements obtained from the leveling sensors and automatically control the leveling thereof to be within a predefined range (e.g., the longitudinal and/or lateral tilting angles thereof to be within predefined angular or radius ranges), e.g., as shown in FIGS. 8 to 11 and described above wherein the control circuit 182 may be a part of the control station 256.

(C) Alignment 376

The alignment function 376 may comprise pipeline joint selection, vehicle alignment, and/or pipeline joint alignment.

(C-1) Pipeline Joint Selection

In some embodiments, the sensing structure 284 may comprise an optical sensor structure or a computer-vision based detecting structure to determine the positions of the pipeline joints on the pipeline-racking vehicle 104. Based on the detection results of the optical sensor structure or a computer-vision based detecting structure, the computing structure 282 may select a pipeline joint 114 on the pipeline-racking vehicle 104 and control the front crane 232 of the pipeline-construction vehicle 106 and/or an actuation structure of the pipeline-racking vehicle 104 to position the selected pipeline joint 104 to the conveying structure 132 of the pipeline-racking vehicle 104 for feeding into the pipeline-construction vehicle 106.

(C-2) Vehicle Alignment

In some embodiments, the sensing structure 284 may comprise one or more alignment sensors on the pipeline-racking vehicle 104 and the pipeline-construction vehicle 106. The computing structure 282 uses the alignment sensors for ensuring the vehicle alignment therebetween. FIGS. 24 to 26 show an example.

As shown in FIG. 24, in one embodiment, the pipeline-racking vehicle 104 comprises a laser emitter 402 emitting a laser beam 404 towards the pipeline-construction vehicle 106. Correspondingly, the pipeline-construction vehicle 106 comprises a plurality of laser sensors 406 for receiving the laser beam 404. The plurality of laser sensors 406 comprise a central laser sensor 406A and peripheral laser sensors surrounding thereabout. As shown in FIG. 24, when the central laser sensor 406A receives the laser beam 404, the pipeline-racking vehicle 104 and the pipeline-construction vehicle 106 are aligned.

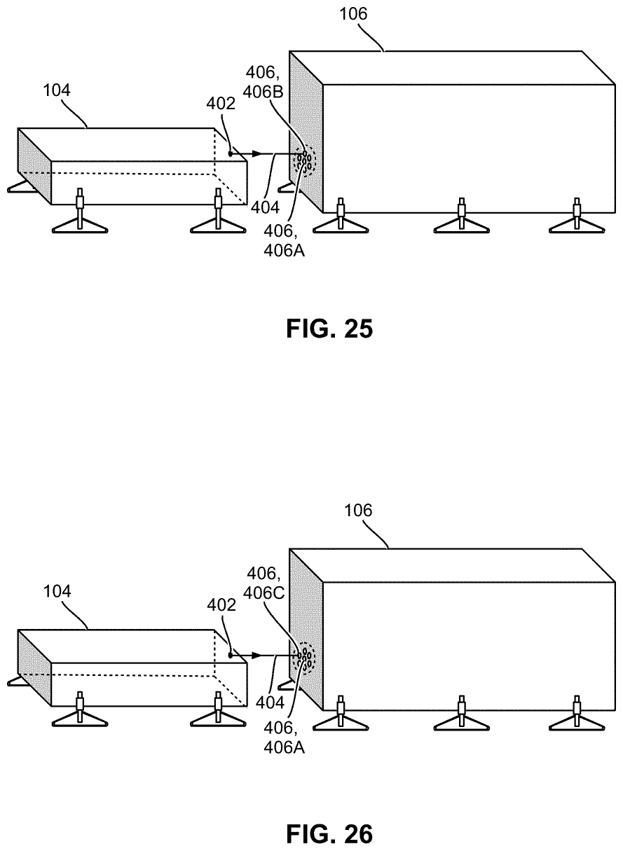

In the example shown in FIG. 25, a peripheral laser sensor 406B located above the central laser sensor 406A receives the laser beam 404, indicating that the pipeline-racking vehicle 104 and the pipeline-construction vehicle 106 are vertically misaligned with the pipeline-racking vehicle 104 leveled at a height higher than that of the pipeline-construction vehicle 106. Based on this alignment detection result, the computing structure 282 may instruct the pipeline-racking vehicle 104 to reduce its height and/or the pipeline-construction vehicle 106 to raise its height until the central laser sensor 406A receives the laser beam 404.

In the example shown in FIG. 26, a peripheral laser sensor 406C located on a laterally right-hand side of the central laser sensor 406A receives the laser beam 404, indicating that the pipeline-racking vehicle 104 and the pipeline-construction vehicle 106 are laterally misaligned with the pipeline-racking vehicle 104 leveled at a height higher than that of the pipeline-construction vehicle 106. Based on this alignment detection result, the computing structure 282 may instruct the pipeline-racking vehicle 104 to move towards its left-hand side and/or the pipeline-construction vehicle 106 to move towards its right-hand side until the central laser sensor 406A receives the laser beam 404.

(C-3) Alignment of Pipeline Joint and Constructed Pipeline

Vehicle alignment generally only provide a coarse alignment and a more precise pipeline joint alignment may be required in some embodiments. Suitable sensors such as laser-based position sensors for measuring the relative positions between the pipeline joint 114 and the constructed pipeline 112. The computing structure 282 uses the position sensor output to adjust the conveying structure 132 of the pipeline-racking vehicle 104 and/or the conveying structure 212 of the pipeline-construction vehicle 106 for ensuring the position and orientation alignments of the between the pipeline joint 114 and the constructed pipeline 112.

In the embodiments shown in FIGS. 14 and 15, the rollers 214 of the conveying structure 212 of the pipeline-construction vehicle 106 are shaped for restricting the lateral movement of the aligned pipeline joint 114.

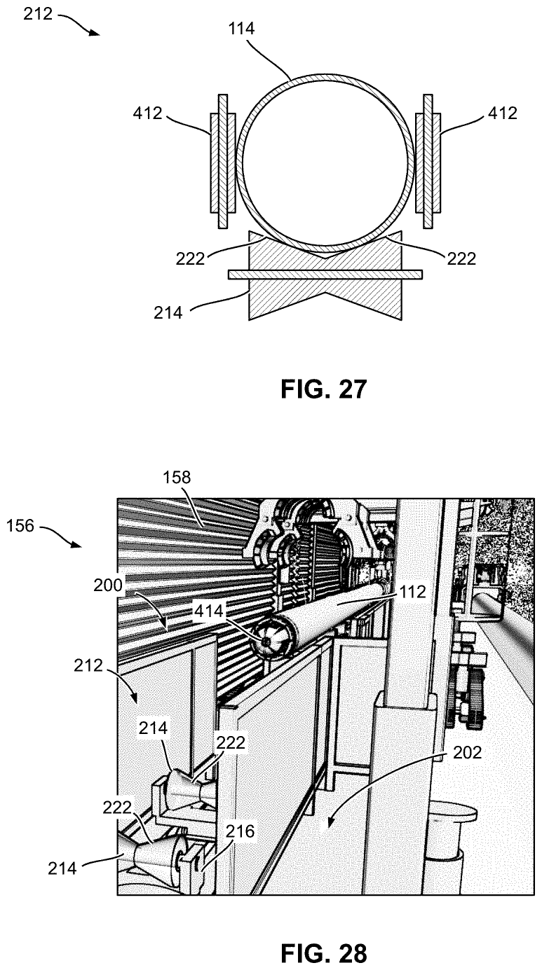

FIG. 27 shows a portion of the conveying structure 212 of the pipeline-construction vehicle 106 in some embodiments. As shown, the conveying structure 212 in these embodiments may further comprise a pair of vertically oriented side-rollers 412 located on the laterally opposite sides of each roller 214. Each pair of side-rollers 412 are spaced from each other with a distance equal to or slightly greater than the outer diameter (OD) of the pipeline joint 114 for further restricting the lateral movement of the aligned pipeline joint 114 when the pipeline joint 114 is passing through the conveying structure 212.

In some embodiments, the automated pipeline-construction system 100 also uses an internal alignment tool for aligning the pipeline joint 114 and the constructed pipeline 112 when the pipeline joint 114 and the constructed pipeline 112 are close to each other.

FIG. 28 shows a portion of the lower level 156 of the pipeline-construction vehicle 106 which accommodates a constructed pipeline 112 in the operation zone 200 thereof. The constructed pipeline 112 movably receives therein an internal alignment and preheat tool 414.

In these embodiments, the internal alignment and preheat tool 414 is a pneumatic or battery powered self-propelled remotely-controllable tool for aligning the pipeline joint 114 and the constructed pipeline 112 and for heating the butt joint thereof for preparation of pipeline construction. The internal alignment and preheat tool 414 uses an internal line-up methodology and comprises a plurality of pneumatic or battery powered internal lineup clamps (not shown) for rapid and accurate alignment of the pipeline joint 114 and the constructed pipeline 112 for a welding operation during pipeline construction.

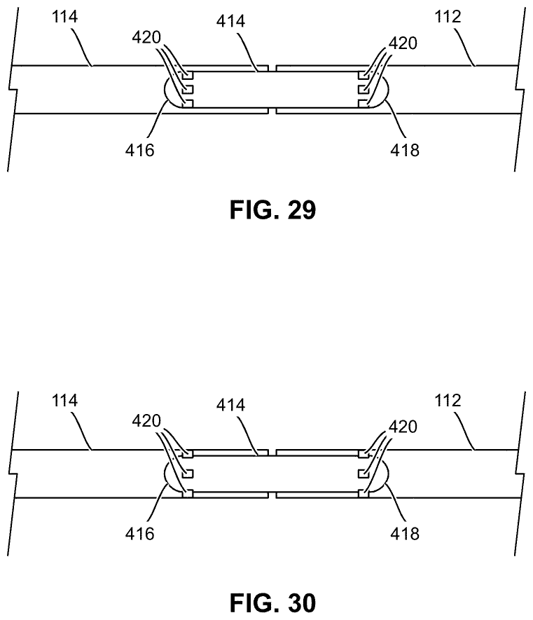

As shown in FIG. 29, the internal alignment and preheat tool 414 comprises a front header 416 and a rear head 418 each having a plurality of radially outwardly extendable clamps 420.

When aligning the pipeline joint 114 and the constructed pipeline 112 the clamps 420 are configured in retrieved positions and the internal alignment and preheat tool 414 longitudinally moves to position itself crossing the butt joint of the pipeline joint 114 and the constructed pipeline 112 such that the front head 416 is in the pipeline joint 114 and the rear head 418 is in the constructed pipeline 112. Then, the front and rear heads 416 and 418 independently operate to radially outwardly extend the clamps 420 thereon to engage the inner surface of the pipeline joint 114 and the constructed pipeline 112 so as to lock the clamps 420 into position.

In these embodiments, each of the front and rear heads 416 and 418 may also comprise specially designed shoes (not shown) for exerting pressure uniformly around the inside circumference of the respective pipe (i.e., the pipeline joint 114 or the constructed pipeline 112) to maintain necessary alignment. Each lineup clamp 420 may be quickly and easily adjusted for different pipe-wall thickness. In some embodiments wherein the internal alignment and preheat tool 414 has a size of 10″ (about 254 mm) or larger, the internal alignment and preheat tool 414 may comprise wheels and/or rollers and may be self-propelled with remotely-controllable powerful air motors (not shown) for moving forward or backward through the pipeline 112 to another joint.

The internal alignment and preheat tool 414 also comprises a heating element (not shown) for heating the aligned pipeline joint 114 and constructed pipeline 112 for welding. For example, the heating element may comprise one or more flexible ceramic heaters and use traditional low-voltage electrical resistance method for heating. In particular, the one or more flexible ceramic heaters are connected to a control unit such as a twin heat module, a heat treatment console, a heat-treatment rig (which is a fully self-contained unit), and/or the like, through one or more secondary cables. A thermocouple is used to monitor the material temperature and provide feedback to the control unit and a temperature recording subsystem.

(D) Tool Control 378

Referring again to FIG. 23, the computing structure 282 may also automatically perform a tool control function 378 for controlling the relative position between each tool assembly 236 and the pipeline joint 114/constructed pipeline 112 in the pipeline-construction vehicle 106, and for controlling the operation of the tool assemblies 236.

In some embodiments, the sensing structure 284 may comprise one or more suitable sensors such as position sensors, tachometers, and/or the like to determine the position of each tool assembly 236. The sensing structure 284 may also comprise one or more suitable sensors for determining the position of the proximal end of the constructed pipeline 112 and the position of the pipeline joint 114 to be coupled to the proximal end of the constructed pipeline 112.

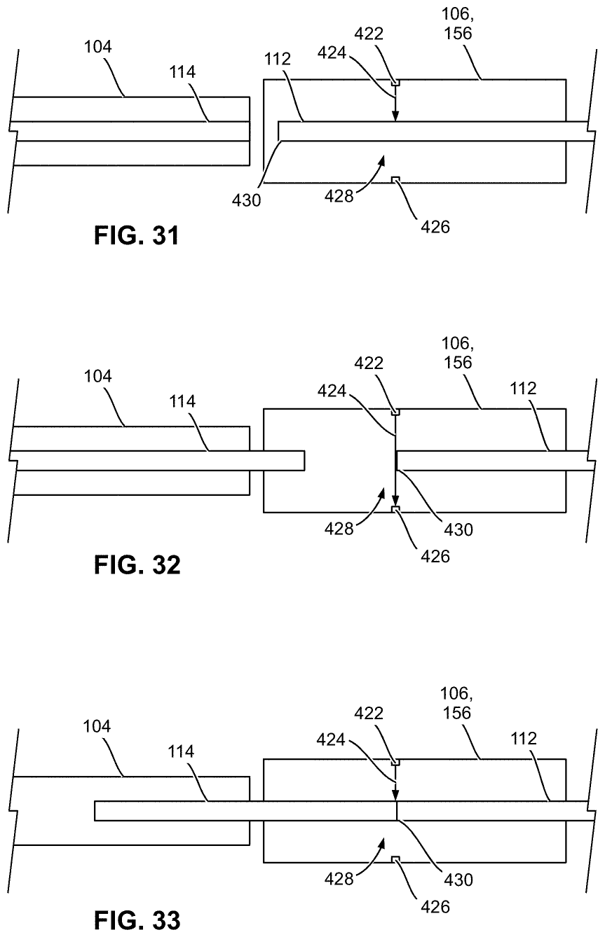

For example, as shown in FIG. 31, the pipeline-construction vehicle 106 comprises a laser emitter 422 emitting a laser beam 424 and a laser sensor 426 on laterally opposite sides of the constructed pipeline 112.

When the constructed pipeline 112 is in a construction position 428, the constructed pipeline 112 blocks the laser beam 424 and thus the laser sensor 426 cannot detect the laser beam 424. Consequently, the computing structure 282 determines that the constructed pipeline 112 needs to move rearward to allow a new pipeline joint 114 to move to the construction position 428.

The computing structure 282 thus instructs the pipeline-racking vehicle 104 and the pipeline-construction vehicle 106 to move forward thereby effectively moving the constructed pipeline rearwardly and deploying the distal portion thereof into the trench 110 (not shown in FIG. 31). As shown in FIG. 32, when the proximal end 430 of the constructed pipeline 112 is moves out of the path of the laser beam 424, the laser detector 426 detects the laser beam 424. Consequently, the computing structure 282 determines that the constructed pipeline 112 has moved to a predefined construction position and instructs the pipeline-racking vehicle 104 and the pipeline-construction vehicle 106 to stop moving.

Also shown in FIG. 32, while the pipeline-racking vehicle 104 and the pipeline-construction vehicle 106 were moving forward, the pipeline-racking vehicle 104 also started to feed a new pipeline joint 114 towards the pipeline-construction vehicle 106.

As shown in FIG. 33, when the pipeline joint 114 abuts the proximal end 430 of the constructed pipeline 112, the pipeline joint 114 blocks the laser beam 424 and the laser detector 426 cannot detect the laser beam 424. Consequently, the computing structure 282 determines that the pipeline joint 114 has arrived the predefined construction position and instructs the conveying structure 212 (not shown in FIG. 33) of the pipeline-construction vehicle 106 to stop moving the pipeline joint 112.

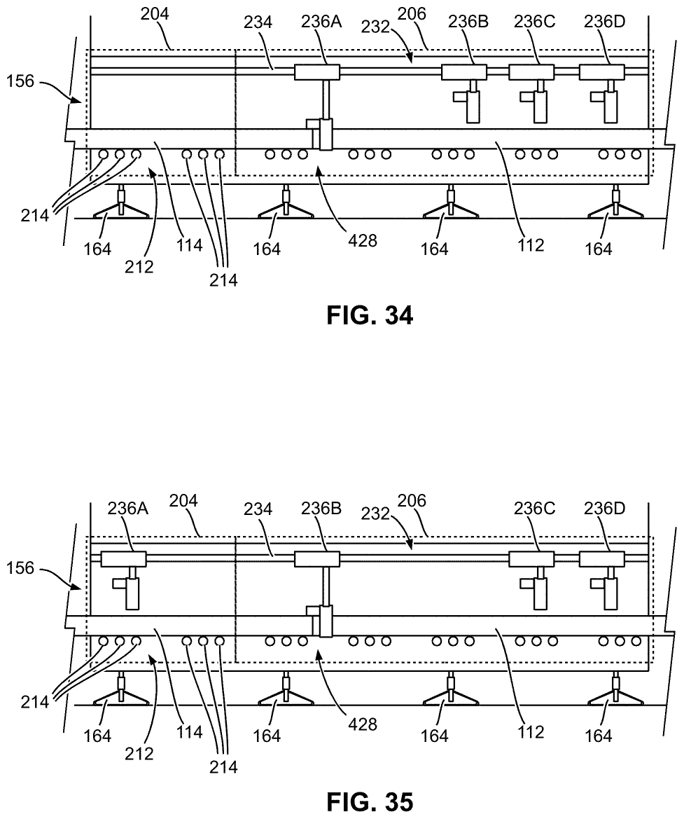

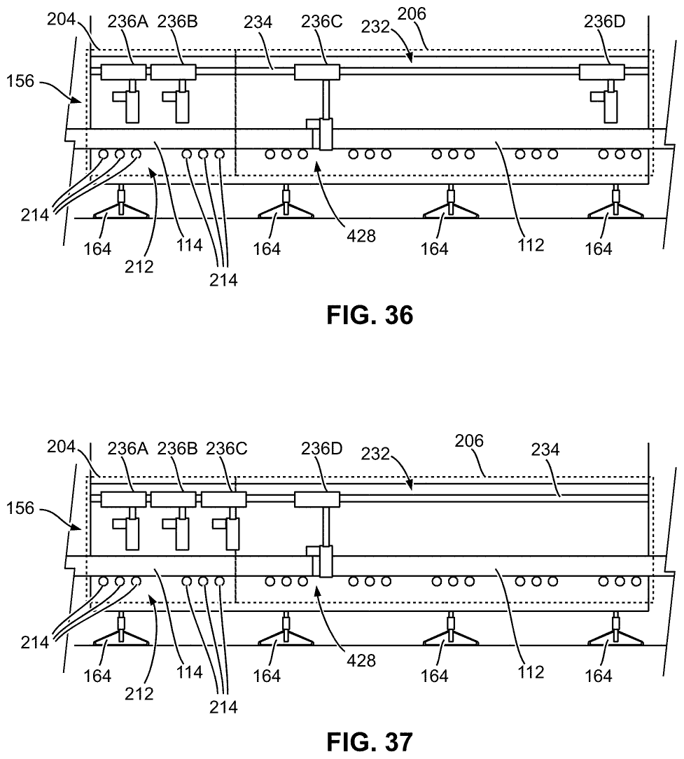

In these embodiments, once the pipeline joint 114 abuts the proximal end 430 of the constructed pipeline 112, the pipeline joint 114 and the constructed pipeline 112 are maintained at the construction position 428 during the pipeline construction and the pipeline-racking vehicle 104 and the pipeline-construction vehicle 106 are in stationary configurations. As shown in FIGS. 34 to 37, the tool assemblies 236A to 236D sequentially move to the construction position 428 for performing pipeline construction tasks. When the pipeline joint 114 is coupled to the constructed pipeline 112, the pipeline-racking vehicle 104 and the pipeline-construction vehicle 106 move forward to deploy the constructed pipeline 112 and move the new proximal end of the constructed pipeline 112 to the construction position 428 for further pipeline construction.

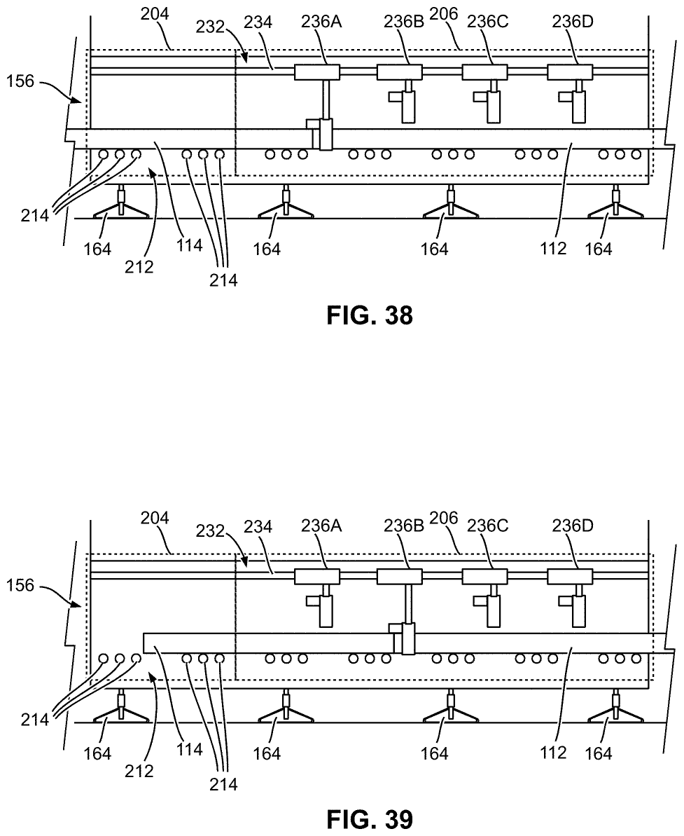

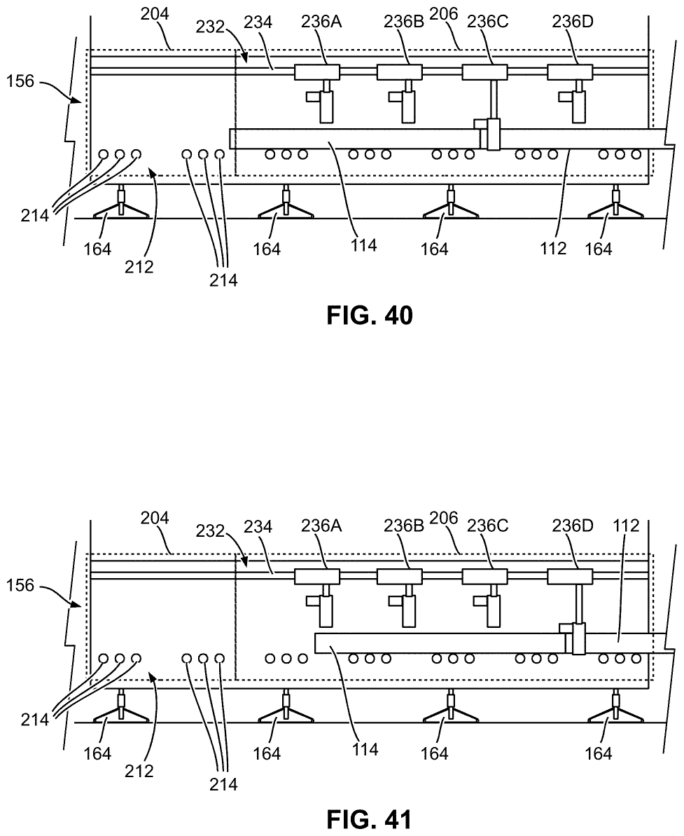

In some embodiments shown in FIGS. 38 to 41, the tool assemblies 236A to 236D are positioned at fixed locations, and therefore the pipeline-construction vehicle 106 comprises a plurality of construction positions each corresponding to a tool assembly 236.

In these embodiments, the pipeline-racking vehicle 104 and the pipeline-construction vehicle 106 first move forward to locate the pipeline joint 114 at the first construction position and stop. The first tool assembly 236A then starts to perform its pipeline-construction task. After the first tool assembly 236A completes its task, the pipeline-racking vehicle 104 and the pipeline-construction vehicle 106 then move forward to locate the pipeline joint 114 to the next construction position and stop to allow the next tool assembly 236 to perform its pipeline-construction task. This process repeats until all tool assemblies 236 have completed their pipeline-construction tasks. The pipeline-racking vehicle 104 and the pipeline-construction vehicle 106 the further move forward to deploy the constructed pipeline 112 and move the new proximal end of the constructed pipeline 112 to the first construction position for further pipeline construction.

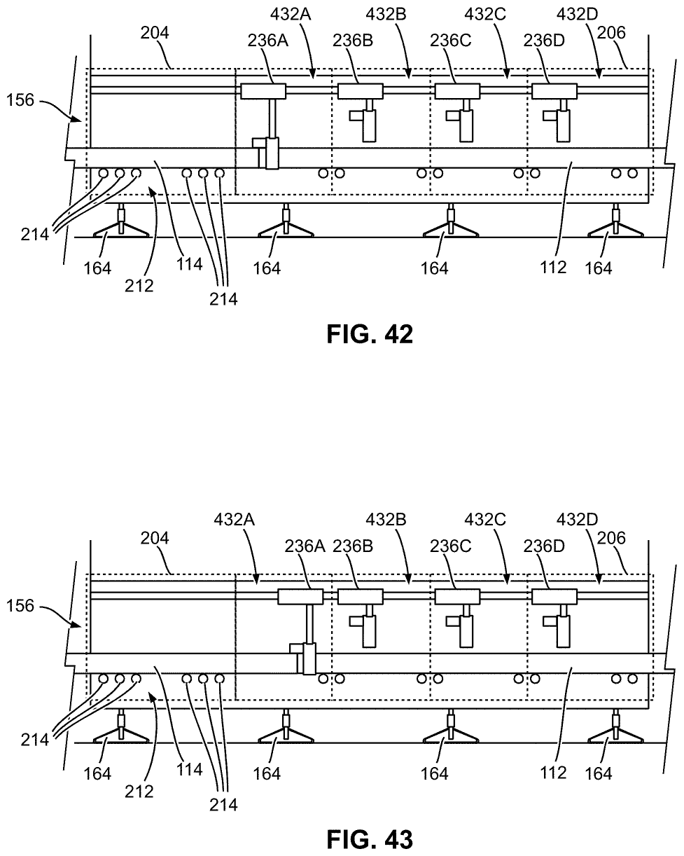

In the embodiments shown in FIGS. 34 to 41, the pipeline-racking vehicle 104 and the pipeline-construction vehicle 106 frequently move and stop during the pipeline-construction process which may cause negative impact to the constructed pipeline 112. In some embodiments as shown in FIGS. 42 to 45, each tool assembly 236 is longitudinally movable within a respective tool-assembly zone 432.

The pipeline-racking vehicle 104 and the pipeline-construction vehicle 106 move forward at a predefined speed during the pipeline-construction process. As shown in FIG. 42, when the butt joint of the pipeline joint 114 and constructed pipeline 112 move into the first tool-assembly zone 432A, the first tool assembly 236A starts to perform its pipeline-construction task while also synchronously move rearwardly with the butt joint of the pipeline joint 114 and constructed pipeline 112 until the butt joint moves to the end of the tool-assembly zone 432A and the first tool assembly 236A has completed its pipeline-construction task (FIG. 43).

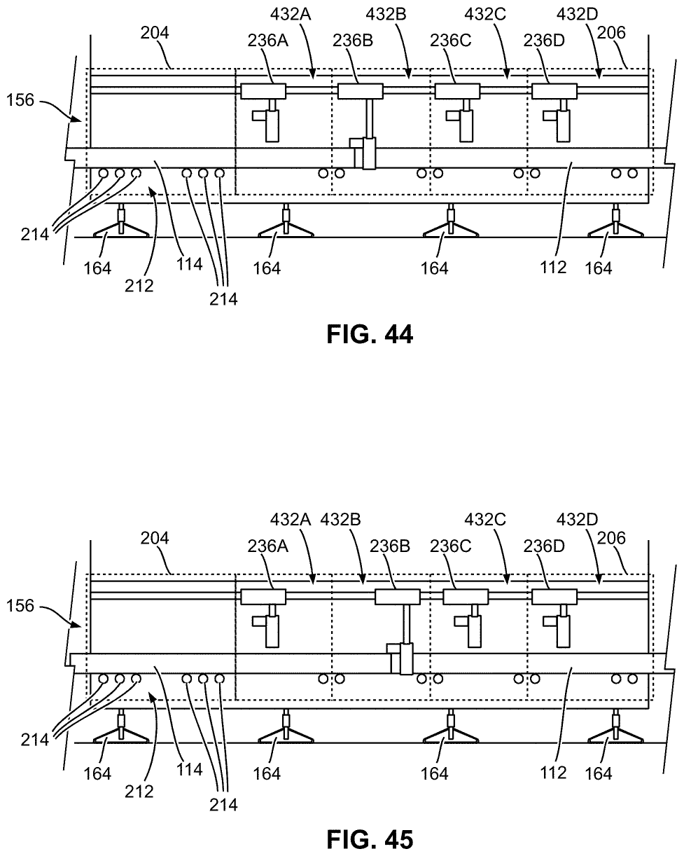

As shown in FIG. 44, when the butt joint of the pipeline joint 114 and constructed pipeline 112 moves into the second tool-assembly zone 432B, the second tool assembly 236B starts to perform its pipeline-construction task while also synchronously move rearwardly with the butt joint of the pipeline joint 114 and constructed pipeline 112 until the butt joint moves to the end of the tool-assembly zone 432B and the second tool assembly 236B has completed its pipeline-construction task (FIG. 45).

This process repeats until all tool assemblies 236 have completed their pipeline-construction tasks. The pipeline-racking vehicle 104 and the pipeline-construction vehicle 106 the further move forward to deploy the constructed pipeline 112 and move the new proximal end of the constructed pipeline 112 to the first construction position for further pipeline construction.

In this manner, the pipeline-racking vehicle 104 and the pipeline-construction vehicle 106 avoid frequent moving and stopping thereby reducing the negative impact to the constructed pipeline 112.

(E) Communication 380

Referring again to FIG. 23, the computing structure 282 may also communicate with remote devices via the network 292 (see FIG. 20) for transmitting and/or receiving various commands and data such as text/audio/video data, sensor data, and/or the like.

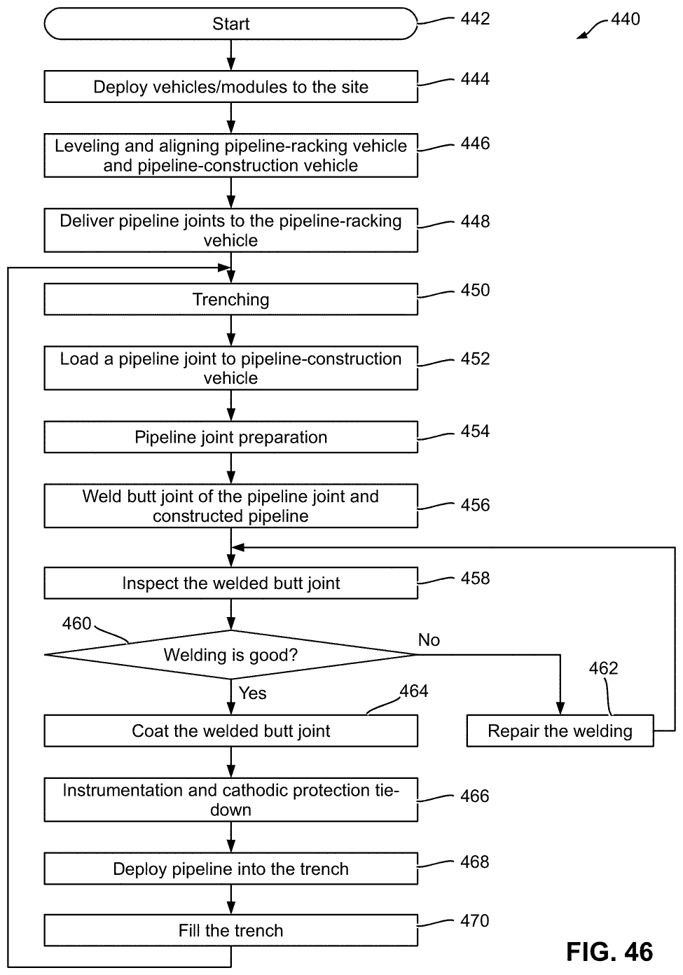

FIG. 46 shows a flowchart illustrating the detailed steps of a pipeline construction and deployment process 440.

When the process 440 starts (step 442), the automated pipeline-construction system 100 is deployed to the pipeline-construction site 102 (step 444). Then, the pipeline-racking vehicle 104 and the pipeline-construction vehicle 106 are leveled and aligned (step 446).

After the automated pipeline-construction system 100 is deployed to the pipeline-construction site 102, a self-propelled delivery module delivers a plurality of pipeline joints 114 to the pipeline-racking vehicle 104 (step 448). A self-propelled trenching module is arranged on the pipeline-construction trail 108 in front of the pipeline-racking vehicle 104 and starts to dig the trench 110 (step 450).

As those skilled in the art will appreciate, in some embodiments, the self-propelled trenching module may be attached to the pipeline-racking vehicle 104. In some other embodiments, the self-propelled trenching module may be detached to the pipeline-racking vehicle 104.

In some embodiments, the self-propelled trenching module may be independently operable. In some embodiments, the self-propelled trenching module may be remotely controlled by the computing structure 282.

At step 452, a pipeline joint 114 is selected and transported from the pipeline-racking vehicle 104 to the pipeline-construction vehicle 106.

In the pipeline-construction vehicle 106, the butt joint of the pipeline joint 114 and the constructed pipeline 112 is prepared or preprocessed (step 454) and a robotic or otherwise automatic welding tool is used to weld the prepared butt joint to couple the pipeline joint 114 to the constructed pipeline 112 to extend the constructed pipeline 112 (step 456).

The welded butt-joint is inspected to determine if the welding has any defects (step 458). If any defect is found at step 458 (the “No” branch of step 460), welding repair is then conducted (step 462) and then the process 440 loops back to step 458 for further welding inspection.

If no defect is found (the “Yes” branch of step 460), the butt joint is completely and reliably welded and the process 440 goes to step 464.

At step 464, the welded butt-joint is coated or shrink-wrapped with a fluid-impermeable and/or a gas-impermeable material. At step 466, instrumentation and cathodic protection components are secured to the constructed pipeline 112. Then, the distal portion of the constructed pipeline 112 is deployed from the rear side of the pipeline-construction vehicle 106 through a stress collar into the trench 110 (step 468). A trench-filling module fills the pipeline-deployed trench 110 (step 470) and the process 440 loops back to step 450 for further pipeline construction and deployment.

The process 440 thus continues until the entire pipeline 112 or a desired section of pipeline 112 is constructed and deployed.

An example of pipeline construction and deployment following the process 440 is now described in detail with assistance of further drawings. In this example, the tool assemblies 236 include the sanding tool 532, welding tool 552, inspection tool 562, the repairing tool 572, the coating tool 582, and the instrumentation tool 592.

As shown in FIGS. 1 and 2, when the pipeline construction and deployment process 440 starts, various vehicles, equipment, and modules of the automated pipeline-construction system 100, including the pipeline-racking vehicle 104, the pipeline-construction vehicle 106, the self-propelled trenching module, and a self-propelled trench-filling module, are deployed to the pipeline-construction site 102 (step 444). At this step, the pipeline-racking vehicle 104 and the pipeline-construction vehicle 106 are arranged along the pipeline-construction trail 108 with the pipeline-racking vehicle 104 in front of the pipeline-construction vehicle 106 (see FIG. 3).

The computing structure 282 then levels and aligns the pipeline-racking vehicle 104 and the pipeline-construction vehicle 106 (step 446), e.g., by using the method shown in FIGS. 24 to 26.

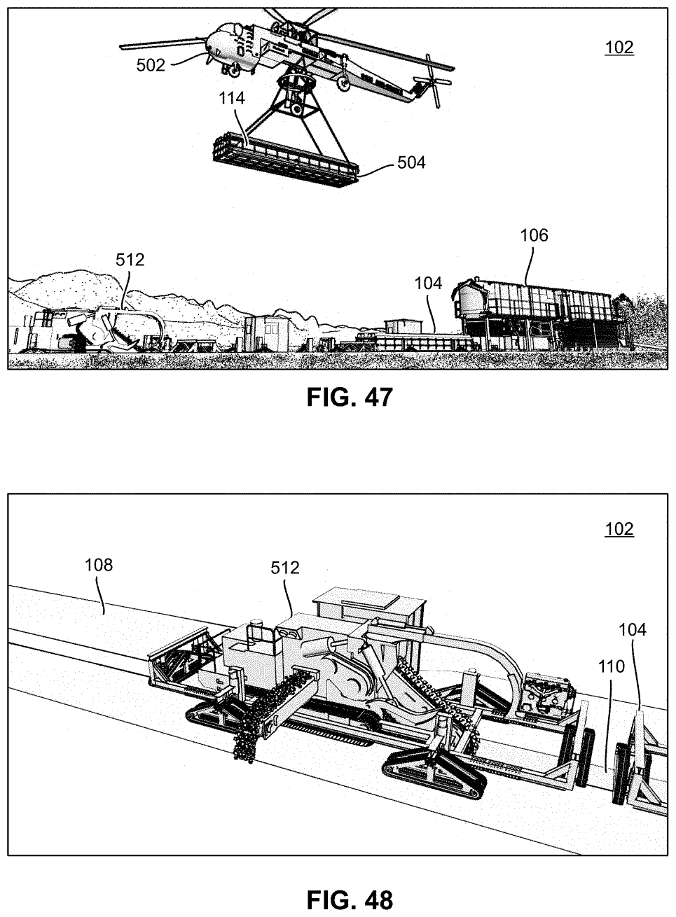

As shown in FIG. 47, a self-propelled delivery module 502 in the form of a transportation helicopter transports a rack 504 having a plurality of pipeline joints 114 to the pipeline-racking vehicle 104 (step 448).

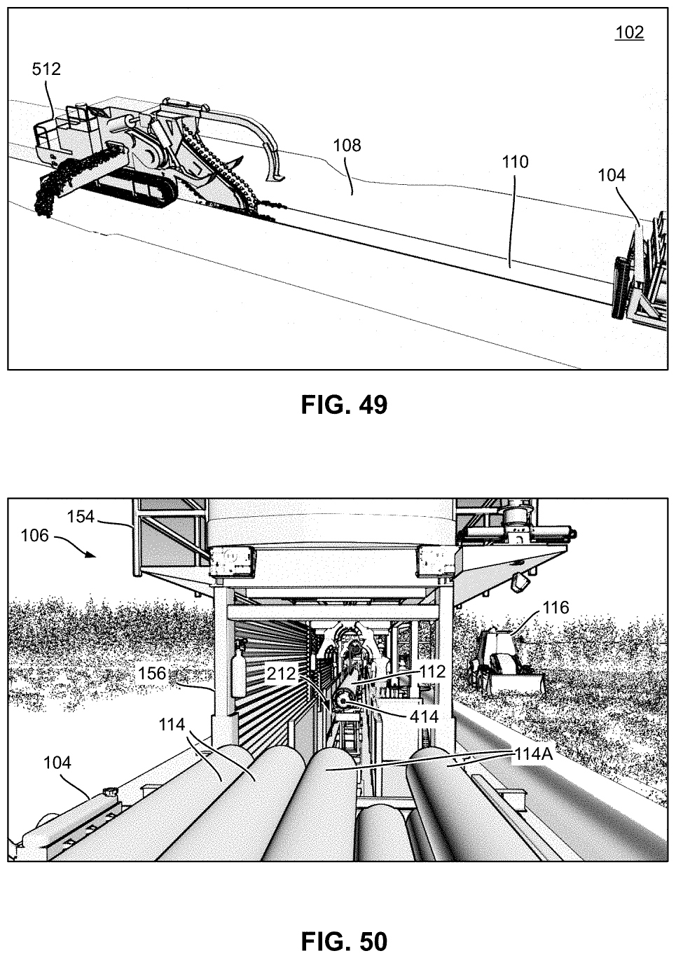

As shown in FIGS. 48 and 49, the self-propelled trenching module 512 is arranged on the pipeline-construction trail 108 in front of the pipeline-racking vehicle 104 and starts to dig the trench 110 (step 450). In this example, the self-propelled trenching module 512 is arranged at a sufficient distance to the pipeline-racking vehicle 104 when digging the trench 110, so as to ensure that the trenching operation would not interfere with the operation of the pipeline-racking vehicle 104 and the pipeline-construction vehicle 106.

As shown in FIG. 50, the computing structure 282 selects a pipeline joint 114A from the pipeline joints 114 in the pipeline-racking vehicle 104 as described above and loads the selected pipeline joint 114A to the conveying structure 132 (not shown in FIG. 50). The conveying structure 132 then conveys the selected pipeline joint 114A to the pipeline-construction vehicle 106 (step 452).

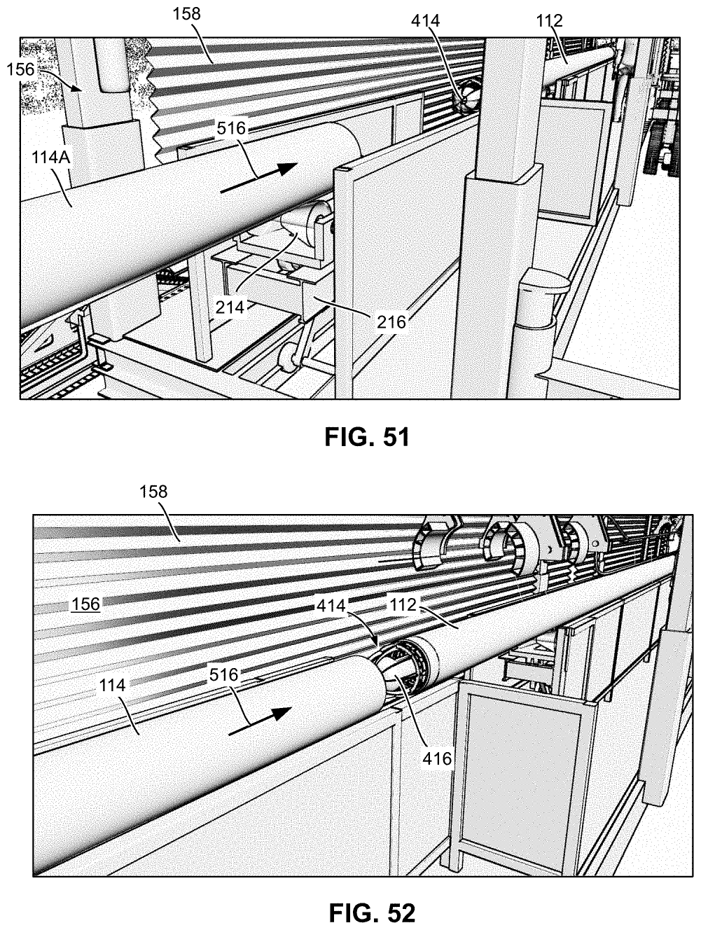

At this step, the computing structure 282 adjusts the height of the conveying structure 132 for aligning the selected pipeline joint 114A with the constructed pipeline 112 in the pipeline-construction vehicle 106. As shown in FIG. 51, the conveying structure 212 of the pipeline-construction vehicle 106 is also adjusted to be ready for receiving the pipeline joint 114A delivered theretowards (indicated by the arrow 516).

As shown in FIG. 52, when the pipeline joint 114A approaches the constructed pipeline 112, the internal alignment and preheat tool 414 moves forward to locate the front head 416 thereof into the pipeline joint 114A while maintaining the rear end 418 thereof (not shown in FIG. 52) in the constructed pipeline 112. The clamps 420 of the internal alignment and preheat tool 414 are then radially outwardly extended to align the pipeline joint 114A with the constructed pipeline 112.

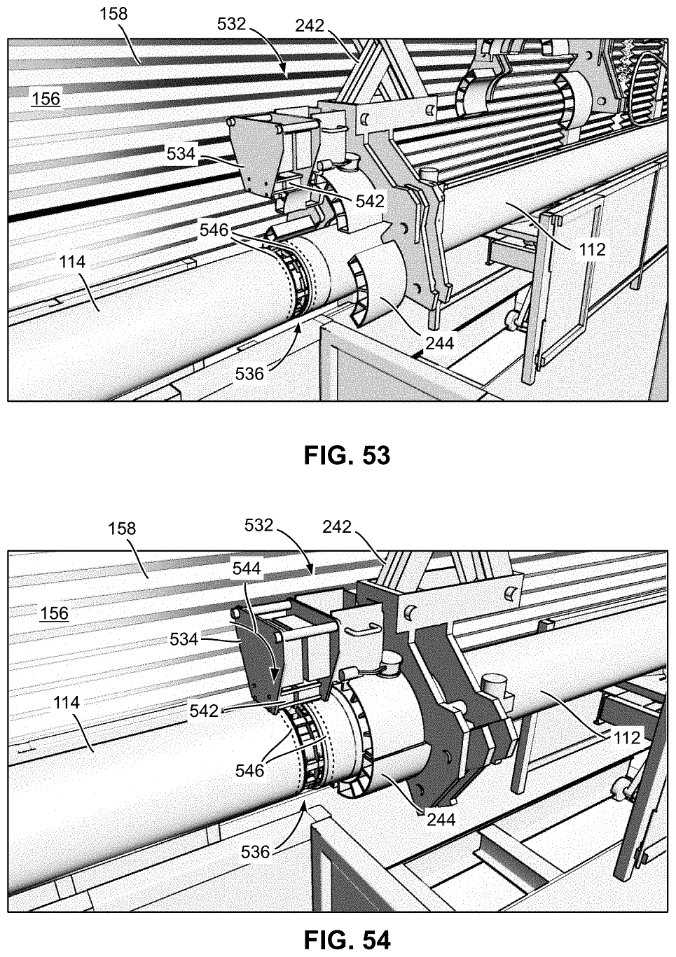

As shown in FIG. 53, the butt joint 536 of pipeline joint 114A and the constructed pipeline 112 are prepared or preprocessed by using a sanding or grinding tool 532 located about the butt joint 536 (step 454). The sanding tool 532 comprises an extendable hanging structure 242 coupled to a clamp 244 and a sanding assembly 534 having one or more sanding blocks 542.

As shown in FIG. 54, the extendable hanging structure 242 is extended to lower the clamp 244 and the sanding assembly 534 to a position adjacent the constructed pipeline 112. The clamp 244 of the sanding tool 532 engages the constructed pipeline 112 to demountably fix the sanding tool 532 about the butt joint 536. Then, the sanding assembly 534 or more specifically the one or more sanding blocks 542 engage the outer surface of the butt joint 536 and rotate thereabout (as indicated by the arrow 544) to sand the welding area 546 thereof. In these embodiments, the sanding tool 532 provides profile shaping and is capable of shaping the welding area 546 to any suitable or required profile and welding type.

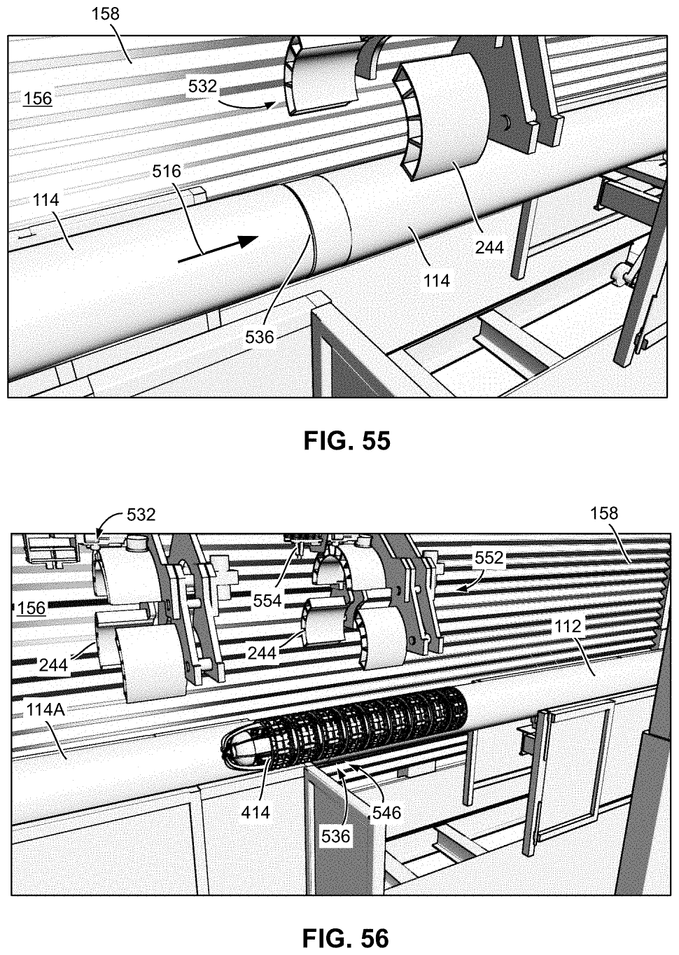

As shown in FIG. 55, after the welding area 546 is sanded, the clamp 244 of the sanding tool 532 is disengaged from the constructed pipeline 112 and the sanding tool 532 is removed from the pipeline joint 114A and the constructed pipeline 112. The pipeline joint 114A is then further moved rearwardly to engage the proximal end of the constructed pipeline 112 as indicated by the arrow 516.

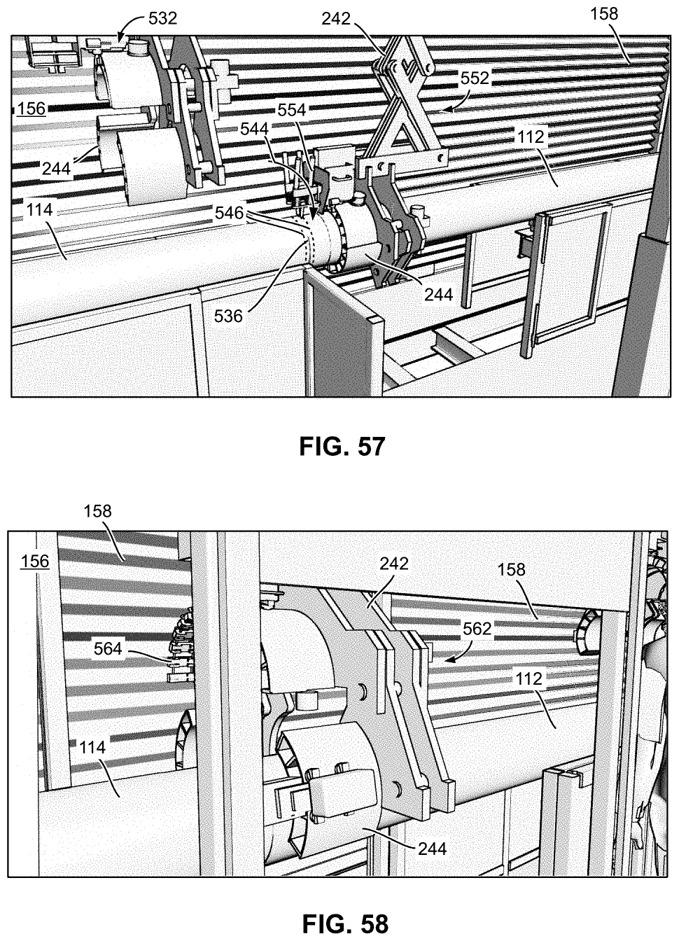

As shown in FIGS. 56 and 57, the pipeline joint 114A and the constructed pipeline 112 are welded together (step 456).

As shown in FIG. 56, the internal alignment and preheat tool 414 inside the butt joint 536 starts to generate heat for heating the welding area to a predefined temperature, as described above. Moreover, a welding tool 552 is moved to a location about the butt joint 536. The welding tool 552 comprises an extendable hanging structure 242 (not shown in FIG. 56) coupled to a clamp 244 and a welding assembly 554.

As shown in FIG. 57, after the welding area 546 is heated, the extendable hanging structure 242 is extended to lower the clamp 244 and the welding assembly 554 to a position adjacent the constructed pipeline 112. The welding assembly 554 then rotates about (as indicated by the arrow 544) and welds the butt joint 536. After welding, the welding tool 552 is removed from the constructed pipeline 112.

In some embodiments, the welding assembly 554 may first circumferentially apply a first weld to join the butt joint, then apply a second weld circumferentially around the butt joint to fill in the first weld, and further apply a cap weld (i.e. a third weld) circumferentially around the butt joint to finish the welding step 456.

As shown in FIG. 58, an inspection tool 562 is located to the butt joint 536 to inspect the welded butt-joint 536 (step 458). Similar to the sanding tool 532 and the welding tool 552, the inspection tool 562 comprises an extendable hanging structure 242 coupled to a clamp 244 and a X-ray based inspection assembly 564.

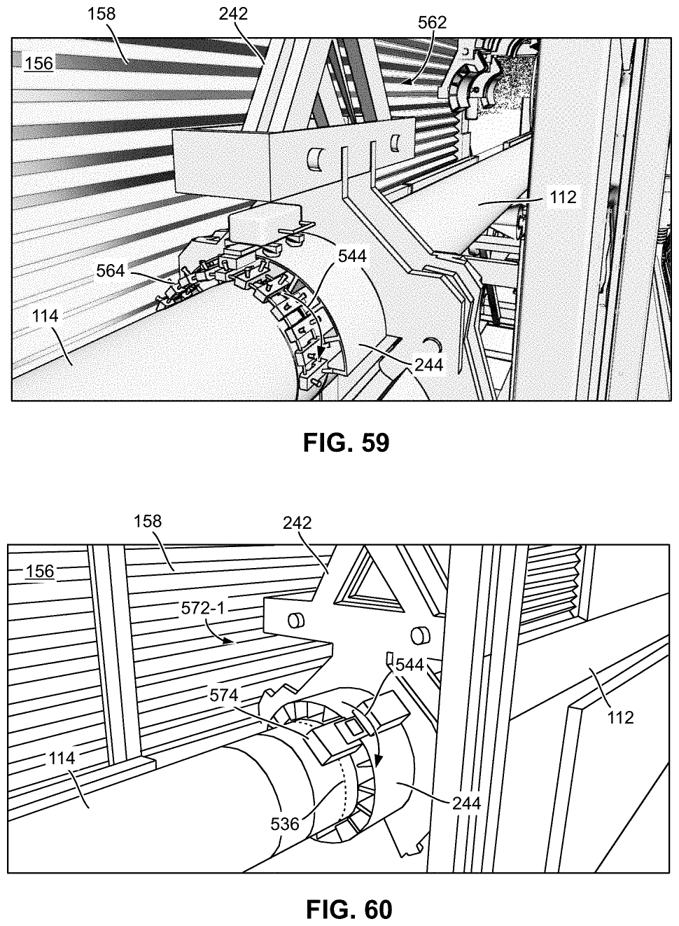

As shown in FIG. 59, the extendable hanging structure 242 is extended to lower the clamp 244 and the inspection assembly 564 to a position adjacent the constructed pipeline 112. The clamp 244 of the inspection tool 562 engages the constructed pipeline 112 to demountably fix the inspection tool 562 about the butt joint 536. Then, the inspection assembly 564 engages the outer surface of the butt joint 536 and rotate thereabout (as indicated by the arrow 544) to use X-ray to inspect the welded butt joint 536.

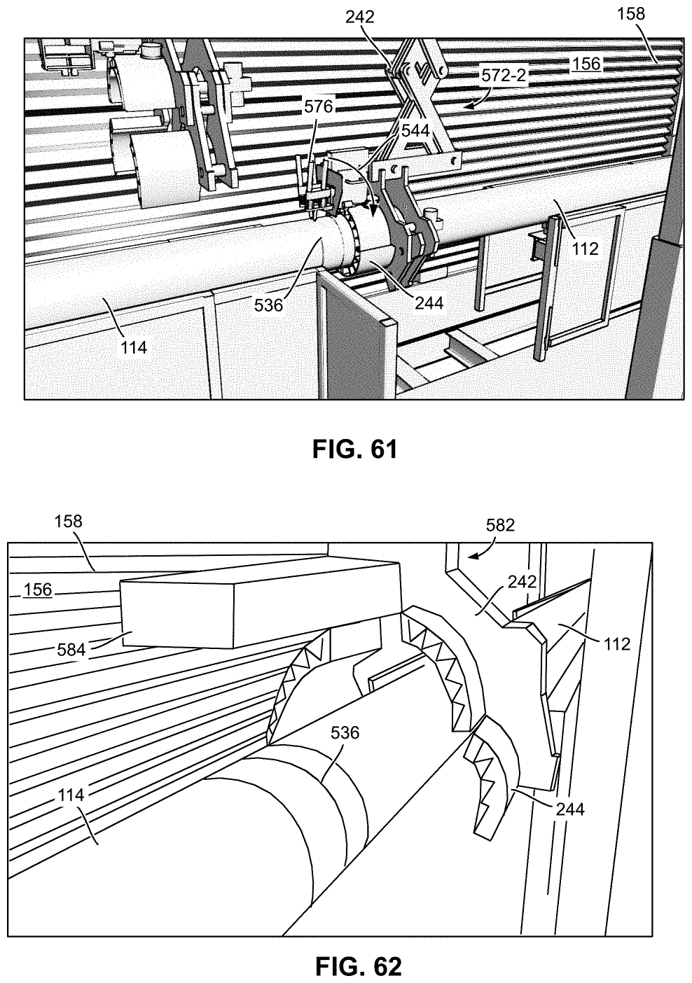

If a defect is found (the “No” branch of step 460), a repairing tool 572 is used for repairing the welding (step 462) as shown in FIGS. 60 and 61.

Depending on the implementation, the repairing tool 572 may be in any suitable form. For example, in the embodiments shown in FIGS. 34 to 37 wherein the pipeline joint 114 and the constructed pipeline 112 are maintained at a predefined construction location of the pipeline-construction vehicle 106 and the tool assemblies 236 are movable to the butt joint during pipeline construction, the sanding tool 532 and the welding tool 552 may act as the repairing tool 572.

On the other hand, in the embodiments shown in FIGS. 38 to 41 wherein the tool assemblies 236 are fixed at predefined locations of the pipeline-construction vehicle 106 and the pipeline joint 114 and the constructed pipeline 112 are movable towards the rear end of the pipeline-construction vehicle 106 (those skilled in the art will appreciate that such a movement is achieved by moving the pipeline-construction vehicle 106 forward), the repairing tool 572 may be a separate tool assembly having a sanding tool and a welding tool.

Similarly, in the embodiments shown in FIGS. 42 to 45 wherein the tool assemblies 236 are only movable within respective tool-assembly zones 432, the repairing tool 572 may be a separate tool assembly having a sanding tool and a welding tool.

For ease of description, the sanding tool and welding tool of the repairing tool 572 are denoted as 572-1 and 572-2 regardless whether the repairing tool 572 is a separate tool assembly or acted by the sanding tool 532 and welding tool 552.

As shown in FIG. 60, the sanding tool 572-1 is first located to the welded butt-joint 536. The clamp 244 of the sanding tool 572-1 engages the constructed pipeline 112 to fix the sanding tool 572-1 about the welded butt-joint 536 and the sand block 574 thereof rotates thereabout (indicated by the arrow 544) to prepare the surface of the welded butt-joint 536 for re-welding.

As shown in FIG. 61, after welding preparation, the welding tool 572-2 of the repairing tool 572 is located to the prepared butt joint 536. The clamp 244 of the welding tool 572-2 engages the constructed pipeline 112 to fix the welding tool 572-2 about the prepared butt-joint 536 and the welding assembly 576 thereof rotates thereabout (indicated by the arrow 544) to re-weld the butt joint 536.

The re-welded butt joint 536 may be re-inspected. If the butt joint 536 is completely and reliably welded and no defect is found, the welded butt-joint 536 is then processed for preventing it from fluid and/or gas (step 464).

As shown in FIG. 62, a coating tool 582 is located to the butt joint 536 for coating. The coating tool 582 comprises an extendable hanging structure 242 coupled to a clamp 244 and a coating assembly 584.

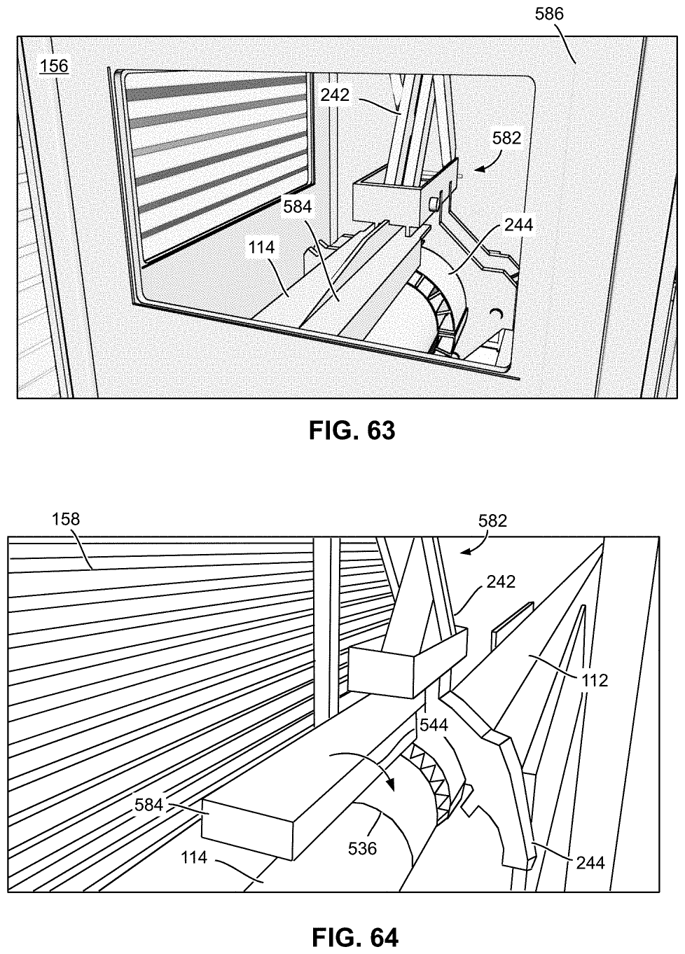

As shown in FIG. 63, the extendable hanging structure 242 is extended to lower the clamp 244 and the coating assembly 584 to a position adjacent the constructed pipeline 112. The clamp 244 of the coating tool 582 engages the constructed pipeline 112 to demountably fix the coating tool 582 about the butt joint 536.

In these embodiments, the coating tool 582 coats the butt joint 536 by spraying a suitable coating material thereto which is fluid-impermeable and/or gas-impermeable when set. To preventing the sprayed coating material from spreading in the pipeline-construction vehicle 106, an enclosure 586 is located to the butt joint 536 and enclosed the coating tool 582 and the butt joint 536 therein. As shown in FIG. 64, the coating assembly 584 then rotates about the butt joint 536 (as indicated by the arrow 544) and spray the coating material thereto.

The coating tool 582 and the enclosure 586 are removed from the constructed pipeline 112 after coating.

In some embodiments, the coating tool 582 applies a fluid-impermeable and/or gas-impermeable shrink-wrapping material to the butt joint 536. In these embodiments, the pipeline-construction vehicle 106 may not comprise an enclosure 586.

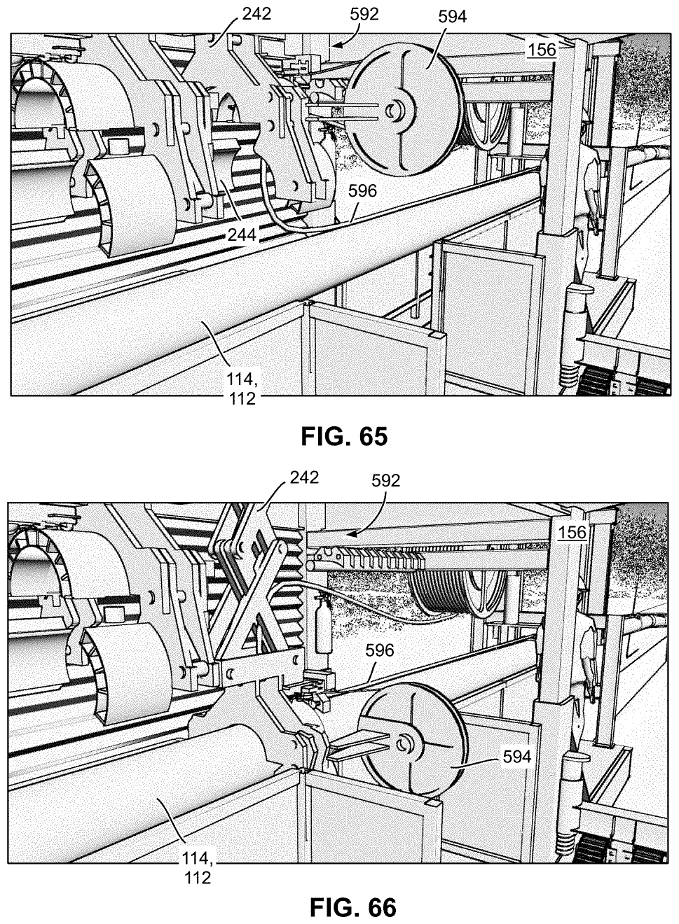

As shown in FIG. 65, after coating, an instrumentation tool 592 is used for securing instrumentation components, cathodic protection components, and/or the like, to the constructed pipeline 112 (step 466). Similar to other tools, the instrumentation tool 592 comprises an extendable hanging structure 242 coupled to a clamp 244 and an instrumentation assembly 594.

As shown in FIG. 66, the extendable hanging structure 242 is extended to lower the clamp 244 and the instrumentation assembly 594 to a position adjacent the constructed pipeline 112. The clamp 244 of the coating tool 582 engages the constructed pipeline 112 to demountably fix the instrumentation tool 592 about the constructed pipeline 112. The instrumentation assembly 594 then installs and secures instrumentation and cathodic protection components 596 such as one or more continuous and endless leak-detection cables to the outer surface of the constructed pipeline 112, wherein the leak-detection cables comprise therealong sensors for detection of volatile and/or liquid fluid components.

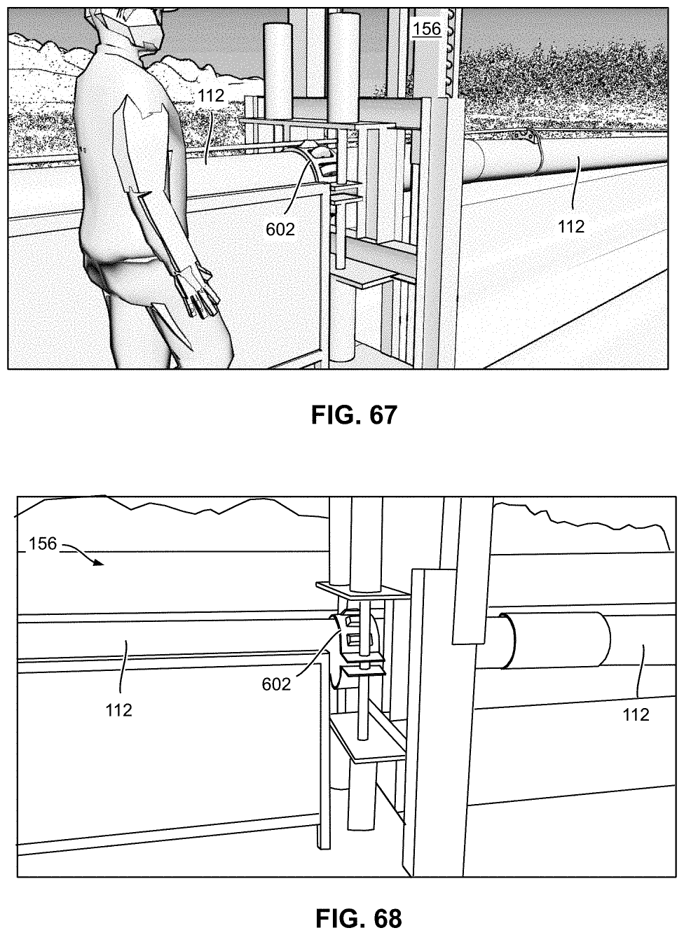

As shown in FIGS. 67 and 68, after the instrumentation and cathodic protection step 466, the constructed pipeline 112 is moved out of the pipeline-construction vehicle 106 and deployed to the trench 110 (step 468).

Specifically, the pipeline-racking vehicle 104 and a pipeline-construction vehicle 106 synchronously move forward to effectively move the constructed pipeline 112 rearward through a stress collar 602. In these embodiments, the stress collar 602 is fixed about the rear end of the pipeline-construction vehicle 106 as a permanent attachment like a cradle to ensure the constructed pipeline 112 to smoothly slide therethrough for deployment into the trench 110. The stress collar 602 is adjustable for adapting to the OD of the constructed pipeline 112.

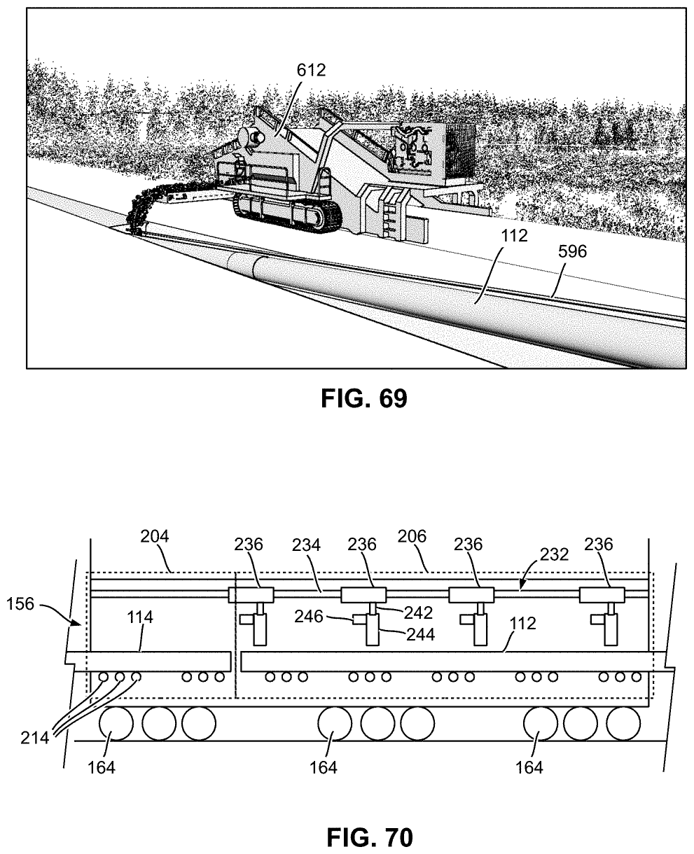

As shown in FIG. 69, with the pipeline-racking vehicle 104 and a pipeline-construction vehicle 106 synchronously moving forward, the constructed pipeline 112 is moved out of the pipeline-construction vehicle 106 and the distal portion thereof is deployed into the trench 110. A trench-filling module 612 in the form of a self-propelled trench-filling vehicle fills the pipeline-deployed trench 110 (step 470).

As described above, the pipeline construction and deployment process may be repeated until the entire pipeline 112 or a desired section of pipeline 112 is constructed and deployed.

Those skilled in the art will appreciate that various alternative embodiments are readily available. For example, while in above embodiments the self-propelled trenching module 512 and the self-propelled trench-filling module 612 are remotely controllable by the computing structure 282, in some alternative embodiments, at least one of the self-propelled trenching module 512 and the self-propelled trench-filling module 612 is manually operable.

As described above, the automated pipeline-construction system 100 may comprise one or more pipeline-racking vehicles 104. The number of the pipeline-racking vehicles 104 may be determined based on a tradeoff of the on-board pipeline-joints carrying capacity, and ease of operation of the pipeline-racking vehicles 104, and the maximum distance between the self-propelled trenching module 512, the pipeline-construction vehicle 106 that may be required, and/or the like.

In above embodiments, the pipeline-racking vehicles 104 and the pipeline-construction vehicle 106 may be pivotably hitched or linked together. In some alternative embodiments, the pipeline-racking vehicles 104 and the pipeline-construction vehicle 106 are not linked together. In these embodiments, the pipeline-racking vehicles 104 and the pipeline-construction vehicle 106 are self-propelled and are remotely controllable by the computing structure 282 to align with each other and synchronously move forward as described above.

Although in above embodiments, the housing 152 of the pipeline-construction vehicle 106 comprises two stories, in some alternative embodiments, the housing 152 of the pipeline-construction vehicle 106 may comprise more than two stories. In yet some alternative embodiments, the housing 152 of the pipeline-construction vehicle 106 may only comprise one story.

In the embodiments shown in FIGS. 24 to 26, the pipeline-racking vehicle 104 and the pipeline-construction vehicle 106 are aligned both laterally and vertically. In some embodiments, the pipeline-racking vehicle 104 and the pipeline-construction vehicle 106 are only aligned laterally. The computing structure 282 uses the conveying structure 132 of the pipeline-racking vehicles 104, the conveying structure 212 of the pipeline-construction vehicle 106, and the internal alignment and preheat tool 414 for aligning the pipeline joint 114 and the constructed pipeline 112 without the need of vertically aligning the pipeline-racking vehicle 104 and the pipeline-construction vehicle 106.

In above embodiments, the pipeline-racking vehicles 104 and the pipeline-construction vehicle 106 comprise a plurality of triangular-shaped track assemblies 164. In some alternative embodiments as shown in FIG. 70, at least one of the pipeline-racking vehicles 104 and the pipeline-construction vehicle 106 may comprise a plurality of wheels 164 with tires having suitable tread for stable ground.

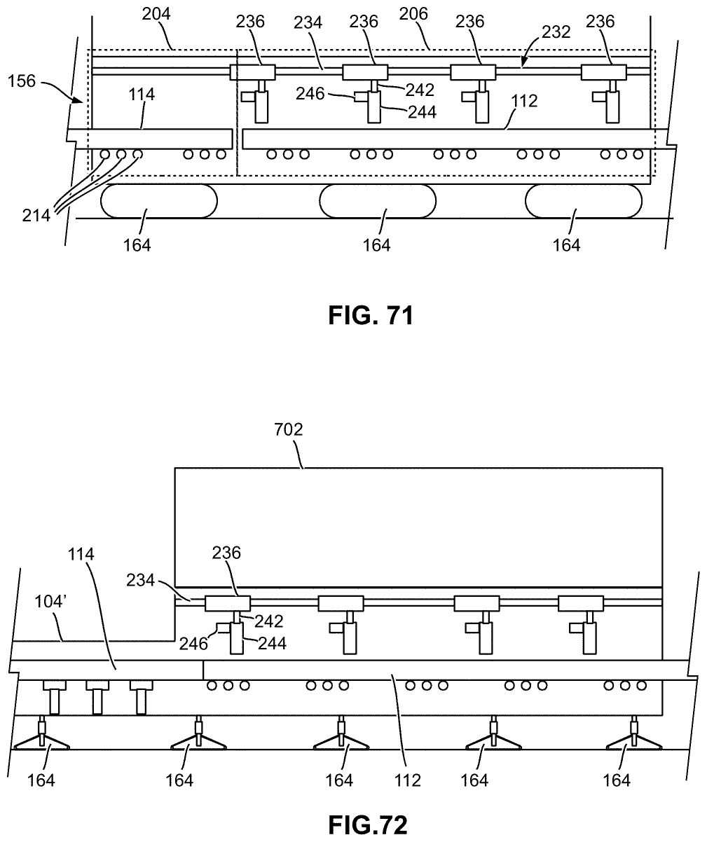

In some alternative embodiments as shown in FIG. 71, at least one of the pipeline-racking vehicles 104 and the pipeline-construction vehicle 106 may comprise a plurality of high-flotation weight-dispersing long-tracks 164 for further lowering the weight pressure exerted on the terrain.

In some alternative embodiments, the pipeline-construction vehicle 106 is remote-controllable. In these embodiments, no operator may be required to stay in and operate the pipeline-construction vehicle 106, and thus the pipeline-construction vehicle 106 may not comprise a monitor-room module 252.

In above embodiments, the pipeline-racking vehicle 104 and the pipeline-construction vehicle 106 are physically separate vehicles. In some embodiments as shown in FIG. 72, the pipeline-racking vehicles 104 and the pipeline-construction vehicle 106 may be integrated into a single pipeline-racking-and-construction vehicle 702. In these embodiments, additional, physically-separated pipeline-racking vehicles 104 may be arranged in from of the pipeline-racking-and-construction vehicle 702 for improved on-board pipeline-joints carrying capacity.

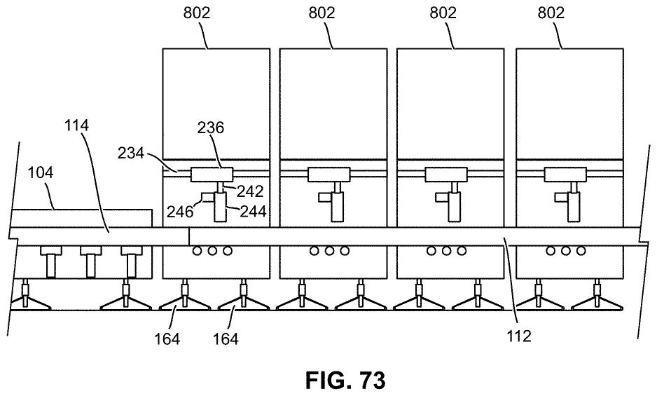

In above embodiments, the automated pipeline-construction system 100 comprises a single pipeline-construction vehicle 106 having a plurality of tool assemblies 236. In some alternative embodiments as shown in FIG. 73, the automated pipeline-construction system 100 may comprise a plurality of pipeline-construction vehicles 802 each having one or more tool assemblies 236 and controlled by the computing structure 282. The computing structure 282 may be distributed on the plurality of pipeline-construction vehicles 802 or may be installed on a master one of the pipeline-construction vehicles 802.

The plurality of pipeline-construction vehicles 802 may be hitched together or pivotably hitched together or linked together. Alternatively, the plurality of pipeline-construction vehicles 802 may not be linked together. In these embodiments, the pipeline-racking vehicle 104 and the pipeline-construction vehicles 802 are self-propelled and are remotely controllable by the computing structure 282 to align with each other and synchronously move forward as described above.

Those skilled in the art will appreciate that, in various embodiments, the one or more pipeline-racking vehicles 104 may be self-propelled or alternatively propelled by the pipeline-construction vehicle 106.

Although not shown in above-described figures, those skilled in the art will appreciate that, in various embodiments, the pipeline-construction vehicle 106 may comprise a source of motive power such as one or more internal-combustion engines of any suitable type, e.g., gas engines, diesel engines, electrical engines/motors, and/or the like.

Those skilled in the art will appreciate that in some embodiments, the automated pipeline-construction system 100 may be used for constructing a pipeline and deploying the constructed pipeline undersea. Those skilled in the art will understand that, in these embodiments, the vehicles described above would be replaced with vessels having same or similar structures and/or functionalities.

In the example shown in FIG. 47, a transportation helicopter is used for transporting a plurality of pipeline joints 114 to the pipeline-racking vehicle 104. In some embodiments, other suitable transportation means such as transportation trucks or vessels (in offshore embodiments) may be used for transporting a plurality of pipeline joints 114 to the pipeline-racking vehicle 104.

In above embodiments, the lower level 156 of the housing 152 of the pipeline-construction vehicle 106 is partitioned into a front, alignment area or section 204 for conveying the received pipeline joint 114 and a rear, construction area or section 206 for constructing the pipeline 112. Such a partition is generally for ease of description and the lower level 156 of the housing 152 may be partitioned in any other suitable manners. For example, in some alternative embodiments, the lower level 156 of the housing 152 of the pipeline-construction vehicle 106 may be partitioned into a front area or section 204 for conveying the received pipeline joint 114, a mid area or section for welding the pipeline 112, and a rear area section for other tasks such as coating and installation of instrumentation and cathodic protection components. Each of the front, mid, and rear sections may comprise a conveyance mount or conveying structure for conveying the pipeline joint 114/constructed pipeline 112 towards the next section or the rear end of the pipeline-construction vehicle 106.

Correspondingly, the rolling chassis 162 of the pipeline-construction vehicle 106 may comprise a first rolling chassis demountably engageable with a second rolling chassis.

The first rolling chassis may comprise or correspond to the front section of the pipeline-construction vehicle 106, and has a first housing or framework having bottom elements engaged with and extending upward from a perimeter of the first rolling chassis, and top elements engaged with and supporting a first superstructure mounted thereon. The first superstructure is configured for housing therein hardware, software, and instrumentation and cathodic protection components for remotely operating, controlling, and monitoring the apparatus, and one or more operator control stations.

The second rolling chassis may comprise or correspond to the mid section and the rear section of the chassis, and has a second housing or framework having bottom elements engaged with and extending upward from a perimeter of the second rolling chassis, and top elements engaged with and supporting a second superstructure mounted thereon. The second superstructure is configured for housing therein the source of motive power.

Although embodiments have been described above with reference to the accompanying drawings, those of skill in the art will appreciate that variations and modifications may be made without departing from the scope thereof as defined by the appended claims.

1. A self-propelled semi-automated remote-controllable apparatus for sealably engaging sections of fluid transmission pipeline joints end-to-end thereby producing a continuous long-distance fluid transmission pipeline for installation between a first location for receiving therefrom a supply of a fluid and a second location for delivery thereto of the fluid, said apparatus comprising:
a source of motive power;
a movable chassis in communication with the source of motive power, said movable chassis having a plurality of height-adjustable suspension structures and having a perimeter encircling a front section, a mid section, and a rear section, wherein:
the front section is provided with a first conveyance mount provided with equipment for (i) receiving, engaging thereon, and conveying therealong to the mid section, an end of a fluid-transmission pipeline joint;
the mid section is provided with remote-controlled equipment for (ii) receiving the end of the fluid transmission pipeline joint from the front section and aligning the end of the pipeline joint with a forward-facing end of a continuous fluid transmission pipeline engaged thereonto a second conveyance mount provided therefor in the mid section, (iii) sealably engaging the end of the fluid transmission pipeline joint with the forward-facing end of the continuous fluid transmission pipeline thereby producing an engaged joint, (iv) inspecting the engaged joint to assess if or if not the engaged joint has been sealably engaged, and (v) repairing the engaged joint if the engaged joint has not been sealably engaged; and
the rear section is provided with a third conveyance mount for receiving thereonto and conveying therealong, a rearward-facing end of the continuous fluid transmission pipeline, and with equipment for (vi) sealable installation of a covering thereonto the engaged joint, (vii) deploying one or more cables adjacent to the continuous fluid transmission pipeline and securing the one or more deployed cables to the continuous fluid transmission pipeline, said one or more cables comprising therealong sensors for detection of volatile and/or liquid fluid components and cathodic protection components;
at least one framework having bottom elements engaged with and extending upward from the perimeter of the movable chassis, and top elements engaged with and supporting (viii) at least one superstructure mounted thereon, said at least one superstructure separated into at least (ix) a first section and (x) a second section wherein the first section houses therein the source of motive power, and the second section houses therein (xi) hardware, software, and instrumentation for remotely operating, controlling, and monitoring the apparatus, and (xii) one or more operator control stations;
wherein the hardware and the software are configured for:
receiving a detection of a longitudinal slope of the apparatus on a longitudinally uneven terrain, wherein the longitudinally uneven terrain has a longitudinal length greater than or equal to that of the apparatus and with a grading having a radius of curvature less than or equal to a predefined threshold radius,
determining that the detected longitudinal slope is out of a predefined longitudinal angular range, and
controlling the plurality of height-adjustable suspension structures to level the apparatus such that the longitudinal slope of the apparatus is within the predefined longitudinal angular range.

2. The self-propelled semi-automated remote-controllable apparatus according to claim 1, wherein the predefined threshold radius is 100 meters (m).

3. The self-propelled semi-automated remote-controllable apparatus according to claim 1, wherein the instructions, when executed, cause the processing structure to perform further actions comprising:
receiving a detection of a lateral slope of the apparatus;
determining that the detected lateral slope is out of a predefined lateral angular range; and
controlling the plurality of height-adjustable suspension structures to level the apparatus such that the lateral slope of the apparatus is within the predefined lateral angular range.

4. The self-propelled semi-automated remote-controllable apparatus according to claim 1, wherein the hardware and the software are further configured for:
receiving an alignment measurement between the front section and a movable and height-adjustable platform in front thereof and carrying a plurality of fluid-transmission pipeline joint to be transferred to the front section;
determining a misalignment between the front section and the movable and height-adjustable platform in front thereof based on the received alignment measurement;
commanding at least one of the plurality of height-adjustable suspension structures of the movable chassis and the movable and height-adjustable platform to adjust at least one of a height thereof and a lateral position thereof to re-align the front section and the movable and height-adjustable platform in front thereof.

5. The self-propelled semi-automated remote-controllable apparatus according to claim 1, wherein the movable chassis comprises a first rolling chassis demountably engageable with a second rolling chassis,
wherein the at least one framework comprises at least a first framework and a second framework,
wherein the at least one superstructure comprises a first superstructure and a second superstructure, and wherein:
the first rolling chassis comprises the front section of the movable chassis, and has the first framework having bottom elements engaged with and extending upward from a perimeter of the first rolling chassis, and top elements engaged with and supporting the first superstructure mounted thereon, said first superstructure configured for housing therein the hardware, the software, and the instrumentation for remotely operating, controlling, and monitoring the apparatus, and the one or more operator control stations; and
the second rolling chassis comprises the mid section and the rear section of the movable chassis, and has the second framework having bottom elements engaged with and extending upward from a perimeter of the second rolling chassis, and top elements engaged with and supporting the second superstructure mounted thereon, said second superstructure configured for housing therein the source of motive power.

6. The self-propelled semi-automated remote-controllable apparatus according to claim 1, wherein the plurality of height-adjustable suspension structures of the movable chassis comprise at least two or more pairs of high-flotation weight-dispersing tires or tracks therealong, said two or more pairs high-flotation weight-dispersing tires or tracks in communication with the source of motive power.

7. The self-propelled semi-automated remote-controllable apparatus according to claim 1, wherein the source of motive power comprises one or more internal-combustion engines; wherein the one or more internal-combustion engines are in communication with one or more electrical-power generators, said electrical-power generators in communication with the movable chassis; wherein said electrical-power generators are in communication with a plurality of electrical-power storage batteries housed in one or more of the movable chassis and the first and/or the second superstructure; and wherein said plurality of electrical-power storage batteries is in communication with the movable chassis.

8. The self-propelled semi-automated remote-controllable apparatus according to claim 1, wherein the source of motive power comprises one or more internal-combustion engines; and the self-propelled semi-automated remote-controllable apparatus additionally comprising an apparatus in communication with the one or more internal-combustion engines to capture excess heat generated therefrom and to generate electrical power from said excess heat whereby the electrical power is transmissible as motive power to the movable chassis and/or in communication with the plurality of electrical-power storage batteries.

9. The self-propelled semi-automated remote-controllable apparatus according to claim 1, wherein the mid section of the movable chassis comprises one or more runway beams for longitudinally movably hanging the remote-controlled equipment.

10. The self-propelled semi-automated remote-controllable apparatus according to claim 1, wherein the remote-controlled equipment of the mid section of the movable chassis comprises a robotic, remote-controllable apparatus for sealably engaging the end of a metal, plastic, or composite fluid-transmission pipeline joint with the forward-facing end of a metal, plastic, or composite continuous fluid transmission pipeline.

11. A system for sealably engaging sections of fluid transmission pipes end-to-end thereby producing a continuous fluid transmission pipeline and for installation of the continuous fluid transmission pipeline between a first location for receiving therefrom a supply of a fluid and a second location for delivery thereto of the fluid, said system comprising:
a self-propelled semi-automated remote-controllable apparatus according to claim 1;
a supply of fluid transmission pipeline joints deliverable to the front section of the self-propelled semi-automated remote-controllable apparatus; and
a computer-implemented method for operation of the self-propelled semi-automated remote-controllable apparatus.

12. The system according to claim 11, wherein the equipment for subterranean installation of the continuous fluid transmission pipeline comprises:
rolling equipment attached or detached to the self-propelled semi-automated remote-controllable apparatus for digging a trench in front thereof; and
rolling equipment for filling in the trench behind the self-propelled semi-automated remote-controllable apparatus.

13. Use of the system according to claim 11, for producing a continuous fluid transmission pipeline for installation of the continuous fluid transmission pipeline along a ground surface from the first location to the second location, for above-ground installation of the continuous fluid transmission pipeline from the first location to the second location, or for subterranean installation of the continuous fluid transmission pipeline from the first location to the second location.

14. A method for producing a continuous fluid transmission pipeline and for installation of the continuous fluid transmission pipeline along a ground surface from a first location to a second location, comprising:
operating the movable chassis of a self-propelled semi-automated remote-controllable apparatus according to claim 1, along a designated path from the first location to the second location;
delivering a plurality of fluid transmission pipeline joints to the front section of the apparatus;
operating the remote-controlled equipment for receiving a front end of one of the fluid transmission pipeline joints from the front section of the apparatus, and
aligning the pipeline joint with a forward-facing end of a continuous fluid transmission pipeline engaged thereonto a second conveyance mount provided therefor in the mid section,
sealably engaging the front end of the fluid transmission pipeline joint with the forward-facing end of the continuous fluid transmission pipeline thereby producing an engaged joint,
inspection of the engaged joint to assess if or if not the engaged joint has been sealably engaged,
repairing the engaged joint if the engaged joint has not been sealably engaged,
sealably installing a covering thereonto the sealably engaged joint,
deploying one or more cables adjacent to the continuous fluid transmission pipeline and securing the one or more deployed cables to the continuous fluid transmission pipeline, said one or more cables comprising sensors therealong for detection of volatile and/or liquid fluid components; and
delivering the continuous fluid transmission pipeline from the rear section of the apparatus onto a ground surface along the designated path.

15. A method for producing a continuous fluid transmission pipeline and for installation of the continuous fluid transmission pipeline onto a series of above-ground supports from a first location to a second location, comprising:
operating the movable chassis of a self-propelled semi-automated remote-controllable apparatus according to claim 1, along a designated path from the first location to the second location;
delivering a plurality of fluid transmission pipeline joints to the front section of the apparatus;
operating the remote-controlled equipment for receiving a front end of one of the fluid transmission pipeline joints from the front section of the apparatus, and
aligning the front end of the received fluid transmission pipeline joint with a forward-facing end of a continuous fluid transmission pipeline engaged thereonto the second conveyance mount provided therefor in the mid section,
sealably engaging the front end of the received fluid transmission pipeline joint with the forward-facing end of the continuous fluid transmission pipeline thereby producing an engaged joint,
inspection of the engaged joint to assess if or if not the engaged joint has been sealably engaged,
repairing the engaged joint if the engaged joint has not been sealably engaged,
sealable installation of a covering thereonto the sealably engaged joint,
deploying one or more cables adjacent to the continuous fluid transmission pipeline and securing the one or more deployed cables to the continuous fluid transmission pipeline, said one or more cables comprising sensors therealong for detection of volatile and/or liquid fluid components;
delivering the continuous fluid transmission pipeline from the rear section of the apparatus onto the series of above-ground support structures; and
securing the continuous fluid transmission pipeline to the series of aboveground support structures.

16. A method for producing a continuous fluid transmission pipeline and for subterranean installation of the continuous fluid transmission pipeline from a first location to a second location, comprising:
providing a trench along a designated path from the first location to the second location;
operating the movable chassis of the self-propelled semi-automated remote-controllable apparatus according to claim 1, along the designated path whereby the apparatus straddles the trench;
delivering a plurality of fluid transmission pipeline joints to the front section of the apparatus;
operating the remote-controlled equipment for receiving a front end of one of the fluid transmission pipeline joints from the front section of the apparatus, and
aligning the front end of the received fluid transmission pipeline joint with a forward-facing end of a continuous fluid transmission pipeline engaged thereonto the second conveyance mount provided therefor in the mid section,
sealably engaging the front end of the received fluid transmission pipeline joint with the forward-facing end of the continuous fluid transmission pipeline thereby producing an engaged joint,
inspection of the engaged joint to assess if or if not the engaged joint has been sealably engaged,
repairing the engaged joint if the engaged joint has not been sealably engaged,
sealable installation of a covering thereonto the sealably engaged joint,
deploying one or more cables adjacent to the continuous fluid transmission pipeline and securing the one or more deployed cables to the continuous fluid transmission pipeline, said one or more cables comprising sensors therealong for detection of volatile and/or liquid fluid components;
delivering the continuous fluid transmission pipeline from the rear section of the apparatus into the trench or laying the continuous fluid transmission pipeline on skids; and
filling in the trench.

17. One or more non-transitory computer-readable storage devices comprising computer-executable instructions for producing a continuous fluid transmission pipeline and for installation of the continuous fluid transmission pipeline along a ground surface from a first location to a second location, wherein the instructions, when executed, cause a processing structure to perform actions comprising:
operating a movable chassis of a self-propelled semi-automated remote-controllable apparatus along a designated path from the first location to the second location, said movable chassis having a plurality of height-adjustable suspension structures;
delivering a plurality of fluid transmission pipeline joints to a front section of the apparatus;
operating a remote-controlled equipment for receiving a front end of one of the fluid transmission pipeline joints from the front section of the apparatus, and
aligning the pipeline joint with a forward-facing end of a continuous fluid transmission pipeline engaged thereonto a second conveyance mount provided therefor in a mid section of the apparatus,
sealably engaging the front end of the received fluid transmission pipeline joint with the forward-facing end of the continuous fluid transmission pipeline thereby producing an engaged joint,
inspection of the engaged joint to assess if or if not the engaged joint has been sealably engaged,
repairing the engaged joint if the engaged joint has not been sealably engaged,
sealable installation of a covering thereonto the sealably engaged joint,
deploying one or more cables adjacent to the continuous fluid transmission pipeline and securing the one or more deployed cables to the continuous fluid transmission pipeline, said one or more cables comprising sensors therealong for detection of volatile and/or liquid fluid components; and
delivering the continuous fluid transmission pipeline from a rear section of the apparatus onto a ground surface along the designated path;
wherein the instructions, when executed, cause the processing structure to perform further actions comprising:
receiving a detection of a longitudinal slope of the apparatus on a longitudinally uneven terrain, wherein the longitudinally uneven terrain has a longitudinal length greater than or equal to that of the apparatus and with a grading having a radius of curvature less than or equal to a predefined threshold radius;
determining that the detected longitudinal slope is out of a predefined longitudinal angular range; and
controlling the plurality of height-adjustable suspension structures to level the apparatus such that the longitudinal slope of the apparatus is within the predefined longitudinal angular range.

18. The one or more non-transitory computer-readable storage devices according to claim 17, wherein the predefined threshold radius is 100 meters (m).

19. The one or more non-transitory computer-readable storage devices according to claim 17, wherein the instructions, when executed, cause the processing structure to perform further actions comprising:
receiving a detection of a lateral slope of the apparatus;
determining that the detected lateral slope is out of a predefined lateral angular range; and
controlling the plurality of height-adjustable suspension structures to level the apparatus such that the lateral slope of the apparatus is within the predefined lateral angular range.

20. The one or more non-transitory computer-readable storage devices according to claim 17, wherein the instructions, when executed, cause the processing structure to perform further actions comprising:
receiving an alignment measurement between the front section and a movable and height-adjustable platform in front thereof and carrying a plurality of fluid-transmission pipeline joint to be transferred to the front section;
determining a misalignment between the front section and the movable and height-adjustable platform in front thereof based on the received alignment measurement;
commanding at least one of the plurality of height-adjustable suspension structures of the movable chassis and the movable and height-adjustable platform to adjust at least one of a height thereof and a lateral position thereof to re-align the front section and the movable and height-adjustable platform in front thereof.
